(19) United States
(12) Patent Application Publication
(10) Pub. No.: US 2015/0378574 A1
(43) Pub. Date: Dec. 31, 2015

(54) GRAPHICAL USER INTERFACE OF A SENSOR BASED DETECTION SYSTEM

(71) Applicants: ALLIED TELESIS HOLDINGS KABUSHIKI KAISHA, TOKYO (JP); ALLIED TELESIS, INC., BOTHELL, WA (US)

(72) Inventors: Joseph L. Gallo, Santa Cruz, CA (US); Ferdinand E. K. de Antoni, Manila (PH); Scott Gill, Makati (PH); Daniel Stellick, Geneva, IL (US)

(21) Appl. No.: 14/315,320

(22) Filed: Jun. 25, 2014

(51) Int. Cl. G06F 3/0484; G06F 17/30

(52) U.S. Cl. CPC G06F 3/04847; G06F 17/30997; G06F 17/3087; G06F 17/30589; G06F 3/04842

(57) ABSTRACT

Provided herein are systems and methods for receiving information associated with a plurality of sensors configured to detect a hazardous condition, wherein the information includes metadata and sensor reading data; and rendering the information on a graphical user interface on a display device, wherein the rendering is configured to identify sensors of the plurality of sensors that satisfy the hazardous condition.

### RELATED APPLICATIONS

This application is related to U.S. patent application Ser. No. 14/281,896, titled “Sensor Based Detection System,” by Joseph L. Gallo et al. (Attorney Docket No. 13-012-00-US), filed May 20, 2014, which application is incorporated herein by reference in its entirety and claims the benefit and priority thereto.

This application is related to U.S. patent application Ser. No. 14/281,901, titled “Sensor Based Detection Management Platform,” by Joseph L. Gallo et al. (Attorney Docket No. 13-013-00-US), filed May 20, 2014, which application is incorporated herein by reference in its entirety and claims the benefit and priority thereto.

This application is related to U.S. patent application Ser. No. ______, titled “Method and System for Representing Sensor Associated Data,” by Joseph L. Gallo et al. (Attorney Docket No. 13-014-00-US), filed Jun. 25, 2014, which application is incorporated herein by reference in its entirety and claims the benefit and priority thereto.

This application is related to U.S. patent application Ser. No. ______, titled “Method and System for Sensor Associated Messaging,” by Joseph L. Gallo et al. (Attorney Docket No. 13-015-00-US), filed Jun. 25, 2014, which application is incorporated herein by reference in its entirety and claims the benefit and priority thereto.

This application is related to U.S. patent application Ser. No. ______, titled “Path Determination of a Sensor Based Detection System,” by Joseph L. Gallo et al. (Attorney Docket No. 13-016-00-US), filed Jun. 25, 2014, which application is incorporated herein by reference in its entirety.

This application is related to U.S. patent application Ser. No. ______, titled “Graphical User Interface for Path Determination of a Sensor Based Detection System,” by Joseph L. Gallo et al. (Attorney Docket No. 13-018-00-US), filed Jun. 25, 2014, which application is incorporated herein by reference in its entirety and claims the benefit and priority thereto.

This application is related to U.S. patent application Ser. No. 14/281,904, titled “Event Management System for a Sensor Based Detection System,” by Joseph L. Gallo et al. (Attorney Docket No. 13-020-00-US), filed May 20, 2014, which application is incorporated herein by reference in its entirety and claims the benefit and priority thereto.

This application is related to U.S. patent application Ser. No. 14/284,009, titled “User Query and Gauge-Reading Relationships,” by Joseph L. Gallo et al. (Attorney Docket No. 13-027-00-US), filed May 21, 2014, which application is incorporated herein by reference in its entirety and claims the benefit and priority thereto.

This application is related to Philippines Patent Application No. 1/2013/000136, titled “A Domain Agnostic Method and System for the Capture, Storage, and Analysis of Sensor Readings,” by Joseph L. Gallo et al. (Attorney Docket No. 13-027-00-PH), filed May 23, 2013, which application is incorporated herein by reference in its entirety and claims the benefit and priority thereto.

### BACKGROUND

As computing technology has advanced, it has proliferated to an increasing number of communicatively connected devices in different areas. Consequently, an increasing amount of data may be being gathered from the increasing number of devices in the different areas. Unfortunately, most of the data that is currently gathered is used for advertising and marketing to end users, which comes at the expense of public health and security.

### SUMMARY

Provided herein are systems and methods for receiving information associated with a plurality of sensors configured to detect a hazardous condition, wherein the information includes metadata and sensor reading data; and rendering the information on a graphical user interface on a display device, wherein the rendering is configured to identify sensors of the plurality of sensors that satisfy the hazardous condition.

### DRAWINGS

FIG. 1 shows an operating environment in accordance with some embodiments.

FIG. 2 shows components of a sensor-based detection system in accordance with some embodiments.

FIG. 3A shows a schematic of a sensor-based detection system and a sensored environment in accordance with some embodiments.

FIG. 3B shows a schematic of a sensor-based detection system and a sensored environment with a hazardous condition in accordance with some embodiments.

FIG. 3C shows a schematic of a sensor-based detection system and a sensored environment with a hazardous condition in a first location in accordance with some embodiments.

FIG. 3D shows a schematic of a sensor-based detection system and a sensored environment with a hazardous condition in a second location in accordance with some embodiments.

FIG. 3E shows a schematic of a sensor-based detection system and a sensored environment with a hazardous condition in a third location accordance with some embodiments.

FIG. 3F shows a schematic of a sensor-based detection system and a sensored environment with a hazardous condition moved through three locations in accordance with some embodiments.

FIG. 4A shows a schematic of a sensor-based detection system and a sensored environment with a hazardous condition in a first location in accordance with some embodiments.

FIG. 4B shows a schematic of a sensor-based detection system and a sensored environment with a hazardous condition in a second location in accordance with some embodiments.

FIG. 4C shows a schematic of a sensor-based detection system and a sensored environment with a hazardous condition moved through two locations in accordance with some embodiments.

FIG. 5A shows a schematic of a graphical user interface including a map at a first zoom level in accordance with some embodiments.

FIG. 5B shows a schematic of a graphical user interface including a map at a second zoom level in accordance with some embodiments.

FIG. 5C shows a schematic of a graphical user interface including a map at a third zoom level showing a hazardous condition in a first position in accordance with some embodiments.

FIG. 5D shows a schematic of a graphical user interface including a map showing a hazardous condition in a second position in accordance with some embodiments.

FIG. 5E shows a schematic of a graphical user interface including a map showing a hazardous condition in a third position in accordance with some embodiments.

FIG. 6A shows a schematic of a playback control for a graphical user interface including a map showing a hazardous condition in final position in accordance with some embodiments.

FIG. 6B shows a schematic of a playback control for a graphical user interface including a map showing a hazardous condition in an intermediate position in accordance with some embodiments.

FIG. 6C shows a schematic of a playback control for a graphical user interface including a map showing a hazardous condition in an initial position in accordance with some embodiments.

FIG. 7A shows a schematic of a graphical user interface including a map at a first zoom level showing a path for a hazardous condition in a final position in accordance with some embodiments.

FIG. 7B shows a schematic of a graphical user interface including a map at a second zoom level showing a path for a hazardous condition in a final position in accordance with some embodiments.

FIG. 8 shows a schematic of a graph window for graphical user interface including a map showing a path for a hazardous condition in a final position in accordance with some embodiments.

FIG. 9 shows a flow diagram for determining a path in accordance with some embodiments.

FIG. 10 shows a flow diagram for determining a path in accordance with some embodiments.

FIG. 11 shows a flow diagram for rendering sensor-related information on a GUI in accordance with some embodiments.

FIG. 12 shows a flow diagram for rendering sensor-related information on a GUI in accordance with some embodiments.

FIG. 13 shows a flow diagram for rendering a path on a GUI in accordance with some embodiments.

FIG. 14 shows a flow diagram for rendering a path on a GUI in accordance with some embodiments.

FIG. 15 shows a block diagram of a computer system in accordance with some embodiments.

FIG. 16 shows a block diagram of a computer system in accordance with some embodiments.

### DESCRIPTION

Reference will now be made in detail to various embodiments, examples of which are graphically illustrated in the accompanying drawings. While the claimed embodiments will be described in conjunction with various embodiments, it is appreciated that these various embodiments are not intended to limit the scope of the embodiments. On the contrary, the claimed embodiments are intended to cover alternatives, modifications, and equivalents, which may be included within the scope of the appended Claims. Furthermore, in the following detailed description, numerous specific details are set forth in order to provide a thorough understanding of the claimed embodiments. However, it will be evident to one of ordinary skill in the art that the claimed embodiments may be practiced without these specific details. In other instances, well known methods, procedures, components, and circuits are not described in detail so that aspects of the claimed embodiments are not obscured.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that terms such as “receiving,” “converting,” “transmitting,” “storing,” “determining,” “sending,” “querying,” “providing,” “accessing,” “associating,” “configuring,” “initiating,” “customizing,” “mapping,” “modifying,” “analyzing,” “displaying,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client-server environment, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data, that are non-transitory. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

As computing technology has advanced, it has proliferated to an increasing number of communicatively connected devices in different areas. Consequently, an increasing amount of data may be being gathered from the increasing number of devices in the different areas. Unfortunately, most of the data that is currently gathered is used for advertising and marketing to end users, which comes at the expense of public health and security. Accordingly, there is a need to gather and process data from communicatively coupled devices in different areas to provide public health and safety measures.

Embodiments provide methods and systems for monitoring and managing a variety of network (e.g., internet protocol (IP)) connected sensors. Embodiments are configured to allow monitoring (e.g., continuous real-time monitoring, sporadic monitoring, scheduled monitoring, etc.) of sensors and associated sensor readings or data (e.g., ambient sensor readings). For example, gamma radiation levels may be monitored in the context of background radiation levels. Accordingly, a significant change in the background gamma radiation levels may indicate a presence of hazardous radioactive material, bomb, etc. As a result, appropriate actions may be taken to avert a possible security breach, terrorist activity, etc. Embodiments may support any number of sensors and may be scaled upwards or downwards as desired. Embodiments thus provide a universal sensor monitoring, managing, notifying, and/or alerting platform.

Embodiments provide analytics, archiving, status (e.g., real time status, sporadic monitoring, scheduled monitoring, etc.), graphical user interface (GUI) based monitoring and management, and messaging related to any sensor-based detection that may pose a risk to the community. Embodiments may provide a solution for monitoring, managing, notifying, and/or alerting related to certain sensor detection, e.g., gamma radiation detection, air quality detection, water and level quality detection, fire detection, flood detection, biological and chemical detection, air pressure detection, particle count detection, movement and vibration detection, etc. For example, the embodiments may provide a solution for monitoring and tracking movement of hazardous materials or conditions, thereby allowing initiation of public responses and defense mechanisms. Embodiments may allow previously installed devices (e.g., surveillance cameras, smartphones, vibration detection sensors, CO₂ detection sensors, particle detection sensors, air pressure detection sensors, infrared detection sensors, etc.) to be used as sensors to detect hazardous conditions (e.g., radioactive, biological, chemical, etc.). Embodiments may be used in a variety of environments, including public places or venues (e.g., airports, bus terminals, stadiums, concert halls, tourist attractions, public transit systems, etc.), organizations (e.g., businesses, hospitals, freight yards, government offices, defense establishments, nuclear establishments, laboratories, etc.), etc. For example, embodiments may be used to track sensitive material (e.g., nuclear, biological, chemical, etc.) to ensure that it is not released to the public and prevent introduction of the material into public areas. Embodiments may thus be further able to facilitate a rapid response to terrorist threats (e.g., a dirty bomb). It is appreciated that the embodiments are described herein within the context of radiation detection and gamma ray detection for merely illustrative purposes and are not intended to limit the scope.

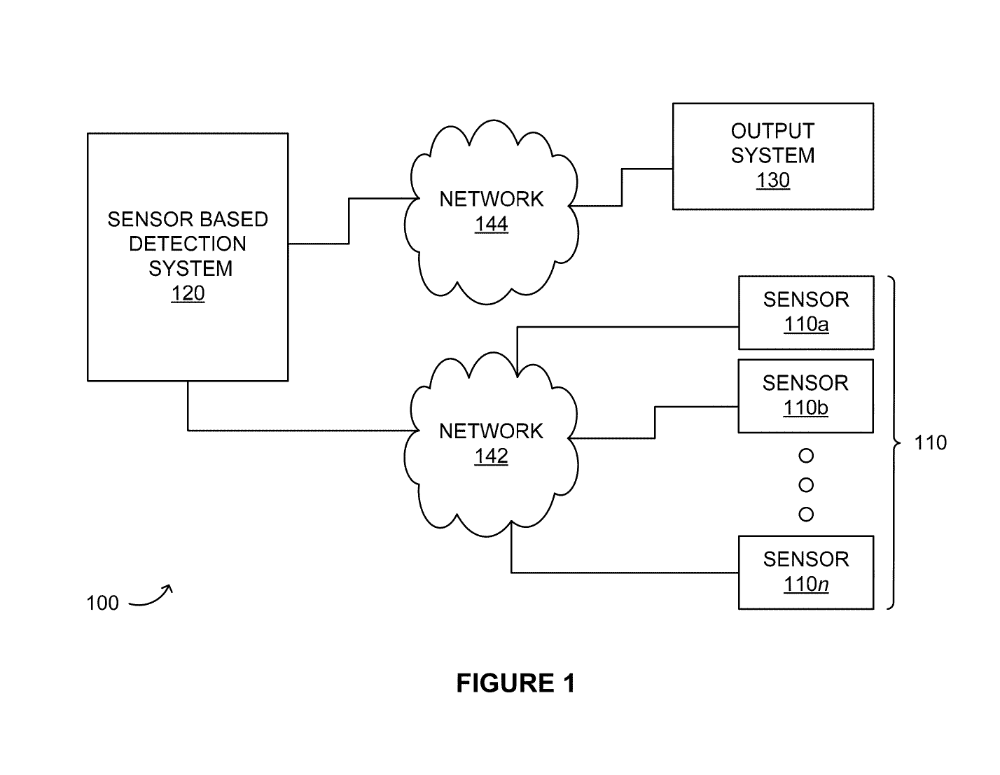

FIG. 1 shows a system in accordance with some embodiments. The system 100 includes a sensor-based detection system 120, a first network 142, a second network 144, an output system 130, and sensors 110, including sensors 110a, 110b, . . . , 110n, wherein n is the n^{th} sensor of any of a number of sensors. The sensor-based detection system 120 and the output system 130 are coupled to the second network 144. The sensor-based detection system 120 and output system 130 are communicatively coupled via the second network 144. The sensor-based detection system 120 and sensors 110 are coupled to the first network 142. The sensor-based detection system 120 and sensors 110 are communicatively coupled via the first network 142. Networks 142 and 144 may include more than one network (e.g., intranets, the Internet, local area networks (LAN)s, wide area networks (WAN)s, etc.), and networks 142 and 144 may be a combination of one or more networks including the Internet. In some embodiments, first network 142 and second network 144 may be a single network.

A sensor of the sensors 110 may generate a reading associated therewith (e.g., gamma radiation, vibration, etc.) associated with a certain condition (e.g., presence of a hazardous condition above a given threshold or within a certain range). and a sensor of the sensors 110 may transmit that information to the sensor-based detection system 120 for analysis. The sensor-based detection system 120 may use the received information to determine whether a reading from a sensor is a calibration reading; a normal or hazard-free reading from a sensor with respect to one or more hazards; an elevated reading from a sensor with respect to the one or more hazards; a potential warning reading from a sensor with respect to the one or more hazards; and a warning from a sensor with respect to the one or more hazards. The sensor-based detection system 120 may compare the received information to one or more threshold values (e.g., historical values, user-selected values, etc.) in order to determine the foregoing. In response to the determination, the sensor-based detection system 120 may transmit that information to the output system 130 for further analysis (e.g., user-based analysis) and/or action (e.g., e-mailing the appropriate personnel; sounding an alarm; tweeting a notification via Twitter™; notifying the police department; notifying the Department of Homeland Security; etc.).

The sensors 110 may be any of a variety of sensors including thermal sensors (e.g., temperature, heat, etc.), electromagnetic sensors (e.g., metal detectors, light sensors, particle sensors, Geiger counter, charge-coupled device (CCD), etc.), mechanical sensors (e.g., tachometer, odometer, etc.), complementary metal-oxide-semiconductor (CMOS), biological/chemical (e.g., toxins, nutrients, etc.), etc. The sensors 110 may further be any of a variety of sensors or a combination thereof including, but not limited to, acoustic, sound, vibration, automotive/transportation, chemical, electrical, magnetic, radio, environmental, weather, moisture, humidity, flow, fluid velocity, ionizing, atomic, subatomic, navigational, position, angle, displacement, distance, speed, acceleration, optical, light imaging, photon, pressure, force, density, level, thermal, heat, temperature, proximity, presence, radiation, Geiger counter, crystal-based portal sensors, biochemical, pressure, air quality, water quality, fire, flood, intrusion detection, motion detection, particle count, water level, surveillance cameras, etc. The sensors 110 may include video cameras (e.g., internet protocol (IP) video cameras) or purpose-built sensors.

The sensors 110 may be fixed in location (e.g., on a building or some other infrastructure, in a room, etc.), semi-fixed in location (e.g., on a cell tower on wheels, affixed to another semi-portable object, etc.), or mobile (e.g., part of a mobile device, smartphone, etc.). The sensors 110 may provide data to the sensor-based detection system 120 according to the type of the sensors 110. For example, sensors 110 may be CMOS sensors configured for gamma radiation detection. Gamma radiation may thus illuminate a pixel, which is converted into an electrical signal and sent to the sensor-based detection system 120.

The sensor-based detection system 120 may be configured to receive data and manage sensors 110. The sensor-based detection system 120 may be configured to assist users in monitoring and tracking sensor readings or levels at one or more locations. The sensor-based detection system 120 may have various components that allow for easy deployment of new sensors within a location (e.g., by an administrator) and allow for monitoring of the sensors to detect events based on user preferences, heuristics, etc. The events may be further analyzed on the output system 130 or used by the output system 130 to generate sensor-based notifications (e.g., based on sensor readings above a threshold for one sensor, based on the sensor readings of two sensors within a certain proximity being above a threshold, etc.) in order for the appropriate personnel to take action. The sensor-based detection system 120 may receive data and manage any number of sensors, which may be located at geographically disparate locations. In some embodiments, the sensors 110 and components of a sensor-based detection system 120 may be distributed over multiple systems (e.g., and virtualized) and a large geographical area.

The sensor-based detection system 120 may track and store location information (e.g., board room B, floor 2, terminal A, etc.) and global positioning system (GPS) coordinates (e.g., latitude, longitude, etc.) for a sensor or group of sensors. The sensor-based detection system 120 may be configured to monitor sensors and track sensor values to determine whether a defined event has occurred (e.g., whether a detected radiation level satisfies a certain condition such as exceeding a certain radiation threshold or range, etc.). As described further herein, if a defined event has occurred, then the sensor-based detection system 120 may determine a route or path a hazardous condition (e.g., dangerous or contraband material) has taken around or within range of the sensors. For example, the path of travel of radioactive material relative to fixed sensors may be determined and displayed via a GUI. It is appreciated that the path of travel of radioactive material relative to mobile sensors (e.g., smartphones, etc.) or relative to a mixture of fixed and mobile sensors may similarly be determined and displayed via a GUI. It is appreciated that the analysis and/or the sensed values may be displayed in real-time or stored for later retrieval.

The sensor-based detection system 120 may include a directly connected output system (e.g., a directly connected display), or the sensor-based detection system 120 may utilize the output system 130 (e.g., a networked display), any of which may be operable for a GUI for monitoring and managing sensors 110. As described further herein, the GUI may be configured for indicating sensor readings, sensor status, sensor locations on a map, etc. The sensor-based detection system 120 may allow review of past sensor readings and movement of sensor detected material or conditions based on stop, play, pause, fast forward, and rewind functionality of stored sensor values. The sensor-based detection system 120 may also allow viewing of an image or video footage (e.g., still images or motion) corresponding to sensors that had sensor readings above a threshold (e.g., based on a predetermined value or based on ambient sensor readings). For example, a sensor may be selected in a GUI and video footage associated with an area within a sensor's range of detection may be displayed, thereby enabling a user to see an individual or person transporting hazardous material. According to some embodiments the footage may be displayed in response to a user selection or it may be displayed automatically in response to a certain event (e.g., sensor reading associated with a particular sensor or group of sensors satisfying a certain condition such as hazardous conditions above a given threshold or within a certain range).

In some embodiments, sensor readings of one or more sensors may be displayed on a graph or chart for easy viewing. A visual map-based display depicting sensors (e.g., sensor representations) may be displayed with the sensors coded (e.g., by color, shape, icon, blinking or flashing rate, etc.) according to the sensors' readings bucketed according to pre-defined hazard levels. For example, gray may be associated with a calibration reading from a sensor; green may be associated with a normal or hazard-free reading from a sensor with respect to one or more hazards; yellow may be associated with an elevated reading from a sensor with respect to the one or more hazards; orange may be associated with a potential warning reading from a sensor with respect to the one or more hazards; and red may be associated with a warning from a sensor with respect to the one or more hazards.

The sensor-based detection system 120 may determine sensor readings above a specified threshold (e.g., predetermined, dynamic, or ambient based) or based on heuristics, and the sensor readings may be displayed in the GUI. The sensor-based detection system 120 may allow a user (e.g., operator) to group multiple sensors together to create an event associated with multiple sensor readings (e.g., warnings or other highly valued sensor readings) from multiple sensors. For example, a code red event may be created when three sensors or more within twenty feet of one another and within the same physical space (e.g., same floor) have a sensor reading that is at least 40% above the historical values. In some embodiments, the sensor-based detection system 120 may automatically group sensors together based on geographical proximity of the sensors (e.g., sensors at Gates 11, 12, and 13 within Terminal 1 at Los Angeles International Airport [LAX] may be grouped together due to their proximity to each other), whereas sensors in different terminals may not be grouped because of their disparate locations. However, in certain circumstances sensors within the same airport may be grouped together in order to monitor events at the airport and not at a more granular level of terminals, gates, etc.

The sensor-based detection system 120 may send information to an output system 130 at any time, including upon the determination of an event created from the information collected from the sensors 110. The output system 130 may include any one or more output devices for processing the information from the sensor-based detection system 120 into a human-comprehendible form (e.g., text, graphic, video, audio, a tactile form such as vibration, etc.). The one or more output devices may include, but are not limited to, output devices selected from printers, plotters, displays, monitors, projectors, televisions, speakers, headphones, and radios. The output system 130 may further include, but is not limited to, one or more messaging systems or platforms selected from a database (e.g., messaging, SQL, or other database); short message service (SMS); multimedia messaging service (MMS); instant messaging services; Twitter™ available from Twitter, Inc. of San Francisco, Calif.; Extensible Markup Language (XML) based messaging service (e.g., for communication with a Fusion center); and JavaScript™ Object Notation (JSON) messaging service. For example, national information exchange model (NIEM) compliant messaging may be used to report chemical, biological, radiological, and nuclear defense (CBRN) suspicious activity reports (SARs) to report to government entities (e.g., local, state, or federal government).

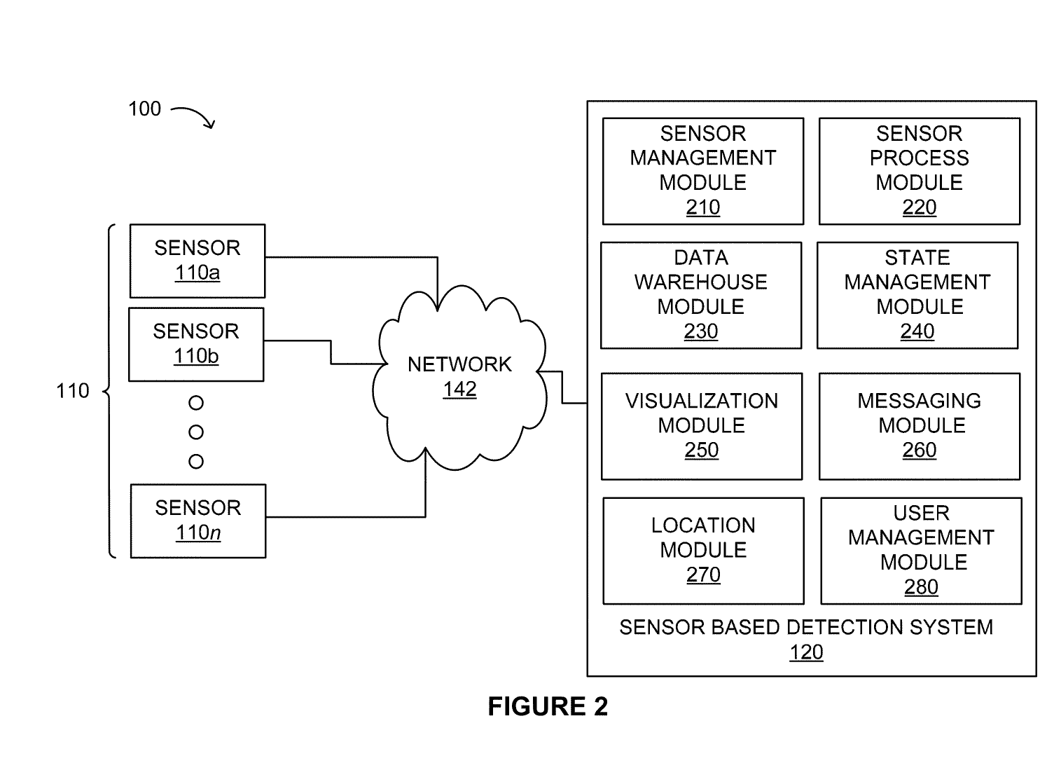

FIG. 2 shows some components of the sensor-based detection system in accordance with some embodiments. The portion of system 100 shown in FIG. 2 includes the sensors 110, the first network 142, and the sensor-based detection system 120. The sensor-based detection system 120 and the sensors 100 are communicatively coupled via the first network 142. The first network 142 may include more than one network (e.g., intranets, the Internet, LANs, WANs, etc.) and may be a combination of one or more networks (e.g., the second network 144) including the Internet. The sensors 110 may be any of a variety of sensors, as described herein.

The sensor-based detection system 120 may access or receive data from the sensors 110. The sensor-based detection system 120 may include a sensor management module 210, a sensor process module 220, a data warehouse module 230, a state management module 240, a visualization module 250, a messaging module 260, a location module 270, and a user management module 280.

In some embodiments, the sensor-based detection system 120 may be distributed over multiple servers (e.g., physical or virtual machines). For example, a domain server may execute the data warehouse module 230 and the visualization module 250, a location server may execute the sensor management module 210 and one or more instances of a sensor process module 220, and a messaging server may execute the messaging module 260. For example, multiple location servers may be located at respective sites having 100 sensors, and provide analytics to a single domain server, which provides a monitoring and management interface (e.g., GUI) and messaging services. The domain server may be centrally located while the location servers may be located proximate to the sensors for bandwidth purposes.

The sensor management module 210 may be configured to monitor and manage the sensors 110. The sensor management module 210 is configured to initiate one or more instances of sensor process module 220 for monitoring and managing the sensors 110. The sensor management module 210 is operable to configure a new sensor process (e.g., an instance of sensor process module 220) when a new sensor is installed. The sensor management module 210 may thus initiate execution of multiple instances of the sensor process module 220. In some embodiments, an instance of the sensor process module 220 is executed for one or more sensors. For example, if there are 50 sensors, 50 instances of sensor process module 220 are executed in order to configure the sensors. It is further appreciated that the sensor management module 210 may also be operable to configure an already existing sensor. For example, the sensor 110a may have been configured previously; however, the sensor management module 210 may reconfigure the sensor 110a based on the new configuration parameters. The sensor management module 210 may be configured as an aggregator and collector of data from the sensors 110 via sensor process module 220. Sensor management module 210 may be configured to send data received via instances of sensor process module 220 to a data warehouse module 230.

The sensor management module 210 further allows monitoring of one or more instances of the sensor process module 220 to determine whether an instance of the sensor process module 220 is running properly or not. In some embodiments, the sensor management module 210 is configured to determine the health of one or more of the sensors 110 including if a sensor has failed based on whether an anticipated or predicted value is received within a certain time period. The sensor management module 210 may further be configured to determine whether data is arriving on time and whether the data indicates that the sensor is functioning properly (e.g., healthy) or not. For example, a radiation sensor may be expected to provide a certain microsievert (μSv) value within a given time period. In some embodiments, the anticipated value may be received from an analytics engine that analyzes the sensor data. In some embodiments, the sensor management module 210 may be configured to receive an indicator of status from a sensor (e.g., an alive signal, an error signal, or an on/off signal). The health information may be used for management of the sensors 110 and the health information associated with the sensors may be stored in the data warehouse 230.

The sensor management module 210 may further access and examine the outputs from the sensors 100 based on a predictable rate of output. For example, an analytics process (e.g., performed by the sensor process module 220) associated with a sensor may produce a record every ten seconds and if a record is not received (e.g., within multiple 10 second periods of time), the sensor management module 210 may stop and restart the analytics process. In some embodiments, the record may be a flat file.

The sensor process module 220 may be configured to receive data (e.g., bulk or raw data) from the sensors 110. In some embodiments, the sensor process module 220 may form a record (e.g., a flat file) based on the data received from the sensors 100. The sensor process module 220 may perform analysis of the raw data (e.g., analyze frames of video to determine sensor readings). In some embodiments, the sensor process module 220 may then pass the records to the sensor management module 210.

The data warehouse module 230 is configured to receive data from sensor management module 210. The data warehouse module 230 may be configured for storing sensor readings and metadata associated with the sensors. Metadata for the sensors may include their respective geographical information (e.g., GPS coordinates, latitude, longitude, etc.), description of the sensor (e.g., Sensor 1 at Gate 1 of Terminal 1 at LAX, etc.). In some embodiments, the data warehouse module 230 may be configured to determine state changes based on monitoring (e.g., real time monitoring) of the state of a sensor and/or the state of the sensor over a time interval (e.g., 30 seconds, 1 minute, 1 hour, etc.). In some embodiments, the data warehouse module 230 is configured to generate a notification (e.g., when a sensor state has changed and is above a threshold or within a certain range; when a sensor reading satisfies a certain condition such as being below a threshold or within a certain range; etc.). The generated notification may be sent to visualization module 250 for display (e.g., to a user) on a directly connected display or a networked display (via output system 130). Changes in sensor state may thus be brought to the attention of a user (e.g., operator). It is appreciated that the threshold values may be one or more historical values, safe readings, operator selected values, etc.

In some embodiments, the data warehouse module 230 may be implemented in a substantially similar manner as described in Philippines Patent Application No. 1-2013-000136 titled, “A Domain Agnostic Method and System for the Capture, Storage, and Analysis of Sensor Reading,” by Ferdinand E. K. de Antoni (Attorney Docket No. 13-027-00-PH), which is incorporated herein by reference in its entirety, and U.S. patent application Ser. No. 14/284,009, titled “User Query and Gauge-Reading Relationships,” by Ferdinand E. K. de Antoni (Attorney Docket No. 13-027-00-US), which is incorporated herein by reference in its entirety.

The state management module 240 may read data from the data warehouse module 230 and/or from the sensor management module 210 (e.g., data that was written by sensor management module 210) and determine whether a state change has occurred. The state change may be determined based on a formula to determine whether there has been a change since a previous record in time for an associated sensor and may take into account ambient sensor readings. If there is a change in state, a notification may be triggered. It is appreciated that state may also be a range of values. One or more notifications may be assembled into an event (e.g., a data structure comprising the one or more notifications). The event may then be accessed by or sent to a visualization module 250 for visualization of the event or the components thereof.

The visualization module 250 may be configured for use in monitoring sensors in a location. The visualization module 250 may provide the GUI or the information therefor for monitoring and managing one or more of the deployed sensors. In some embodiments, the visualization module 250 is configured to provide a tree filter to view the sensors in a hierarchical manner, as well as a map view, thereby allowing monitoring of one or more sensors in a geographical context. The visualization module 250 may further allow creation of an event case file to capture sensor notifications at any point in time and escalate the sensor notifications to appropriate authorities for further analysis (e.g., via a messaging system). The visualization module 250 may display a path of travel or route of hazardous materials or conditions based on sensor readings and the associated sensor locations. The visualization module 250 may further be used to zoom in and zoom out on a group of sensors (e.g., sensors within a terminal at an airport, etc.). As such, the information may be displayed as granular as desired by the operator. Visualization module 250 may also be used and render information in response to a user manipulation. For example, in response to a user selection of a sensor (e.g., sensor 110a) the sensor readings associated with the sensor may be displayed. In another example, a video feed associated with the sensor may also be displayed (e.g., simultaneously).

The messaging module 260 may be configured to send messages to other systems or messaging services including, but not limited to, a database (e.g., messaging, SQL, or other database); short message service (SMS); multimedia messaging service (MMS); instant messaging services; Twitter™ available from Twitter, Inc. of San Francisco, Calif.; Extensible Markup Language (XML) based messaging service (e.g., for communication with a Fusion center); JavaScript™ Object Notation (JSON) messaging service; etc. In one example, national information exchange model (NIEM) compliant messaging may be used to report chemical, biological, radiological, and nuclear defense (CBRN) suspicious activity reports (SARs) to report to government entities (e.g., local, state, or federal government). In some embodiments, the messaging module 260 may send messages based on data received from the sensor management module 210. It is appreciated that the messages may be formatted to comply with the requirements/standards of the messaging service used. For example, as described above a message may be formed into the NIEM format in order to repot a CBRN event.

The location module 270 may be configured for mapping and spatial analysis (e.g., triangulation) in order to represent (e.g., in a human-comprehendible form) one or more hazardous conditions among sensors in a location and/or one or more paths corresponding to the one or more hazardous conditions. For example, location module 270 may be configured to facilitate display of an icon for a hazardous condition among sensor representations (e.g., icons) for sensors at one or more gates of an airport terminal, as well as the path corresponding the hazardous condition. In some embodiments, the sensor management module 210 may be configured to store geographical data associated with a sensor in a data store (not shown) associated with location module 270. It is appreciated that the location module 270 may be used to provide mapping information associated with the sensor location such that the location of the sensor may overlay the map (e.g., location of the sensor may overlay the map of LAX, etc.). It is further appreciated that the location module 270 may be used to provide information associated with a hazardous condition (e.g., current location, path corresponding to the hazardous condition, etc.). The location module 270 may be configured to output information to the visualization module 250 where information related to the sensors and the hazardous condition may be rendered being rendered.

The user management module 280 may be configured for user management and storage of user identifiers of operators and administrators. The user management portion may be integrated with an existing user management systems (e.g., OpenLDAP or Active Director) thereby enabling use of existing user accounts to operate the sensor-based detection system 120.

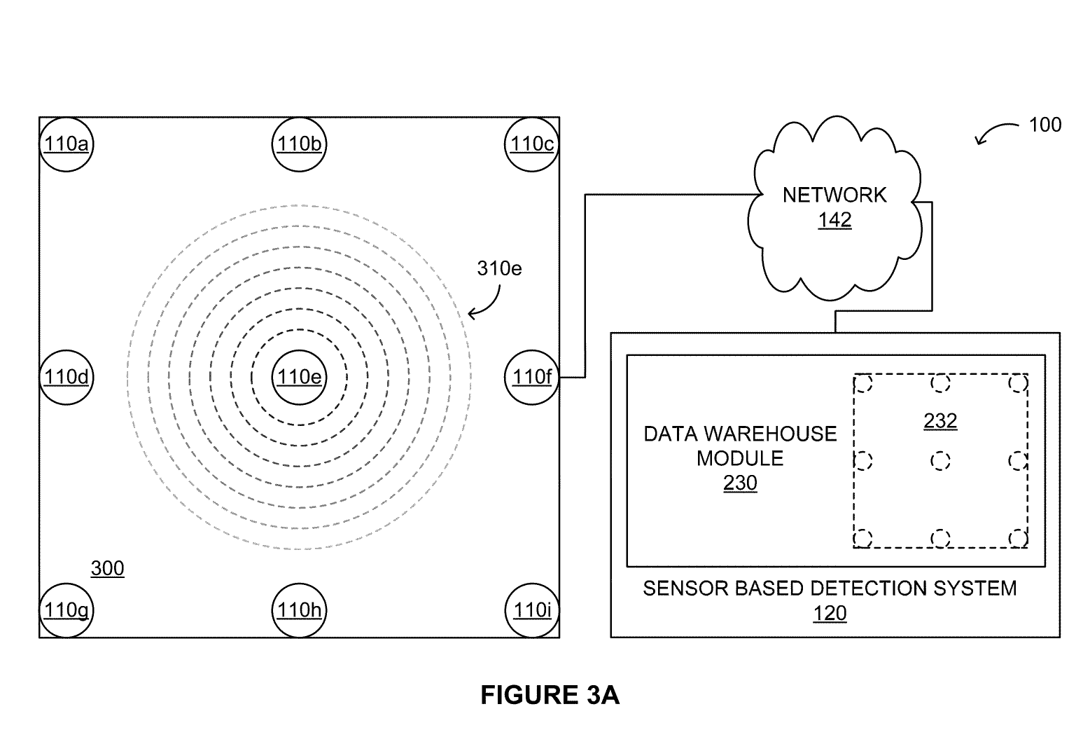

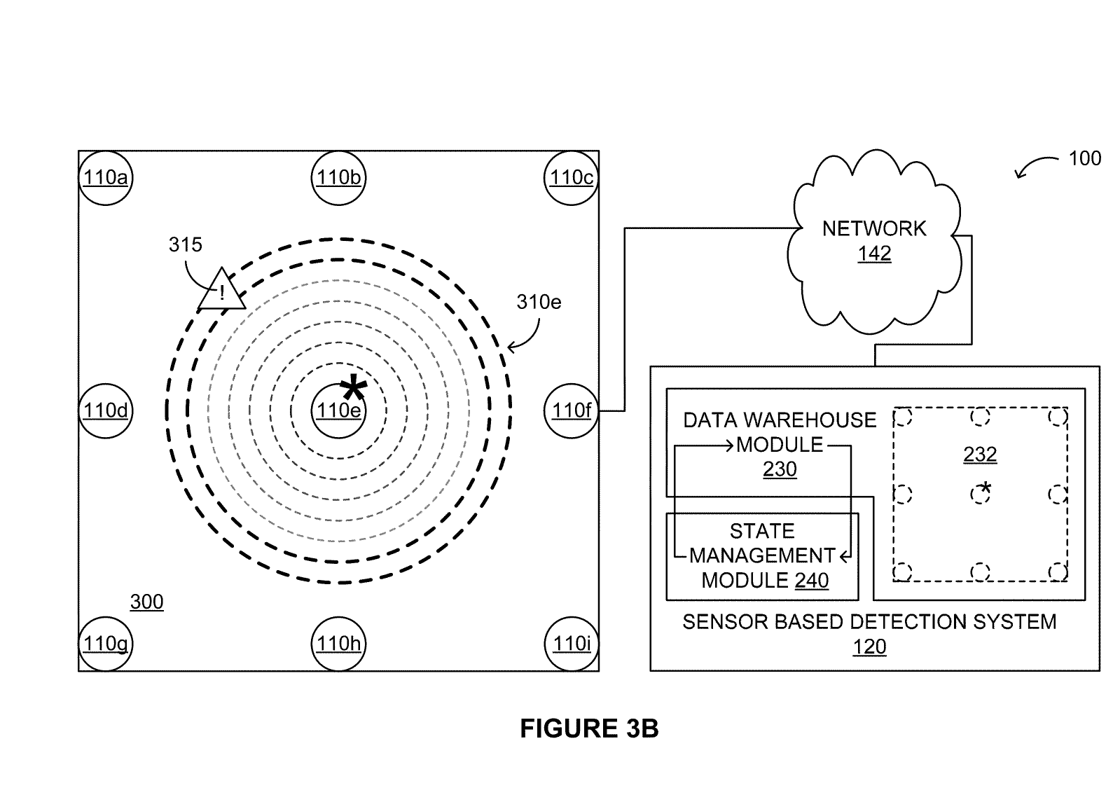

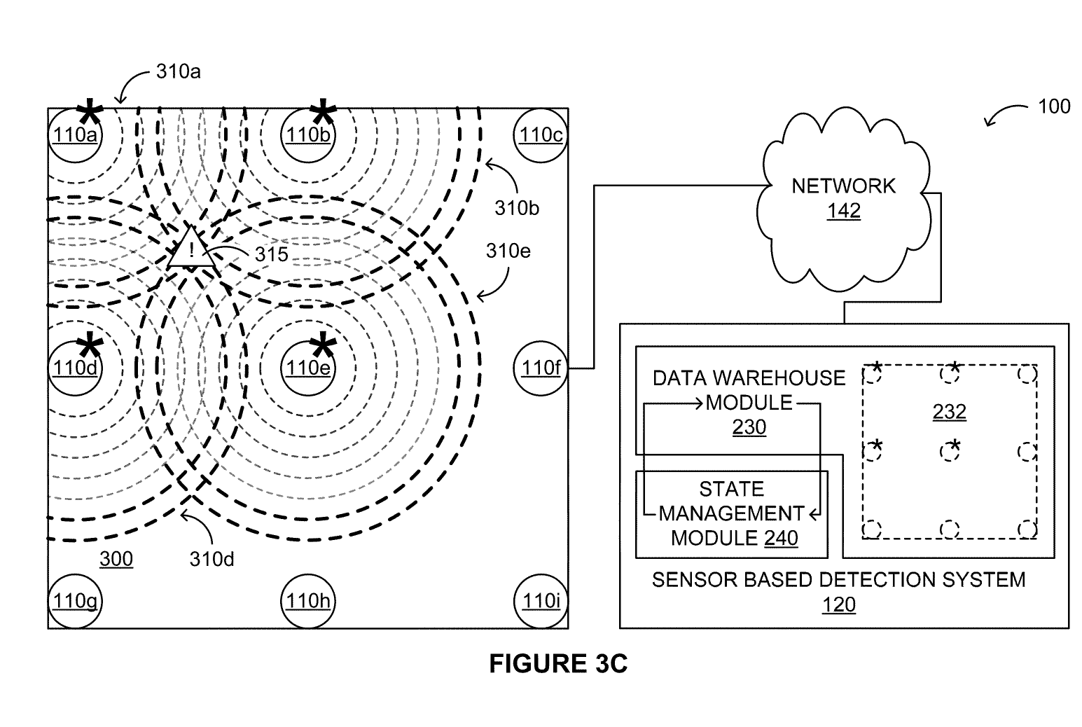

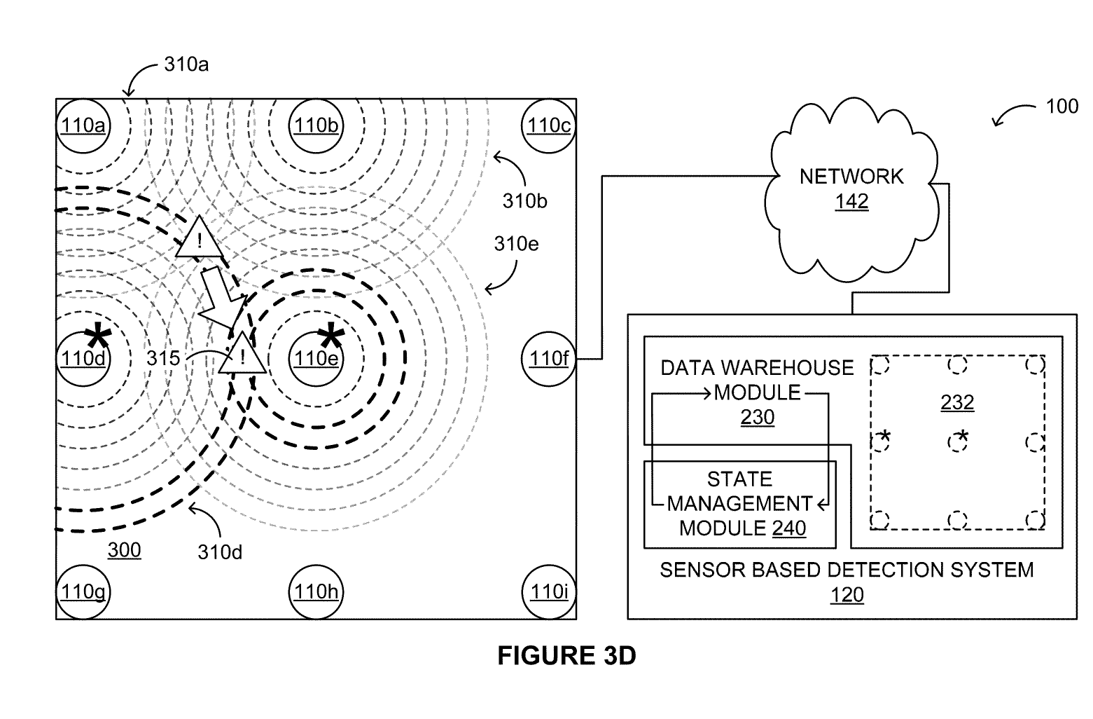

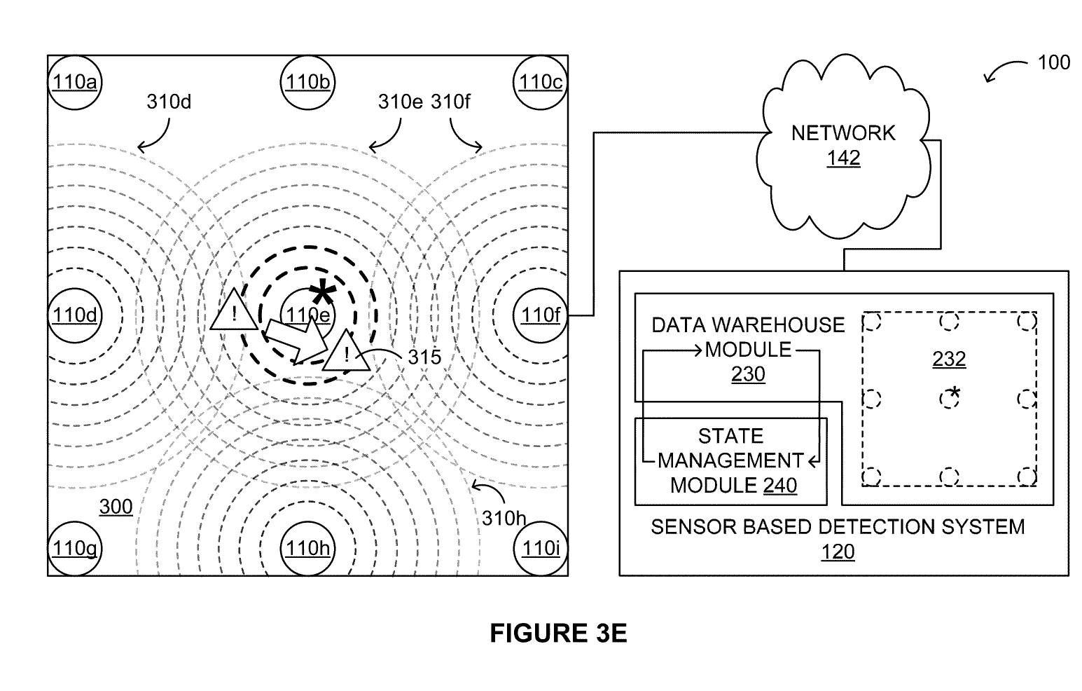

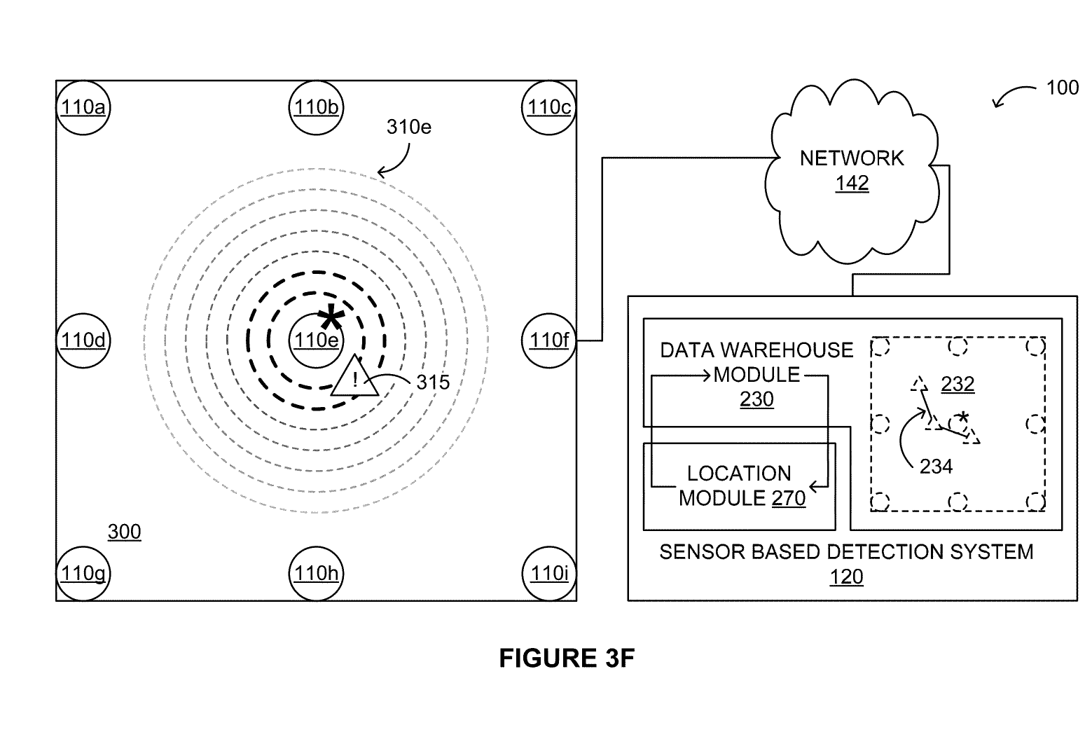

FIGS. 3A-3F provide schematics of a sensor-based detection system and a sensored environment, optionally with a hazardous condition in accordance with some embodiments.

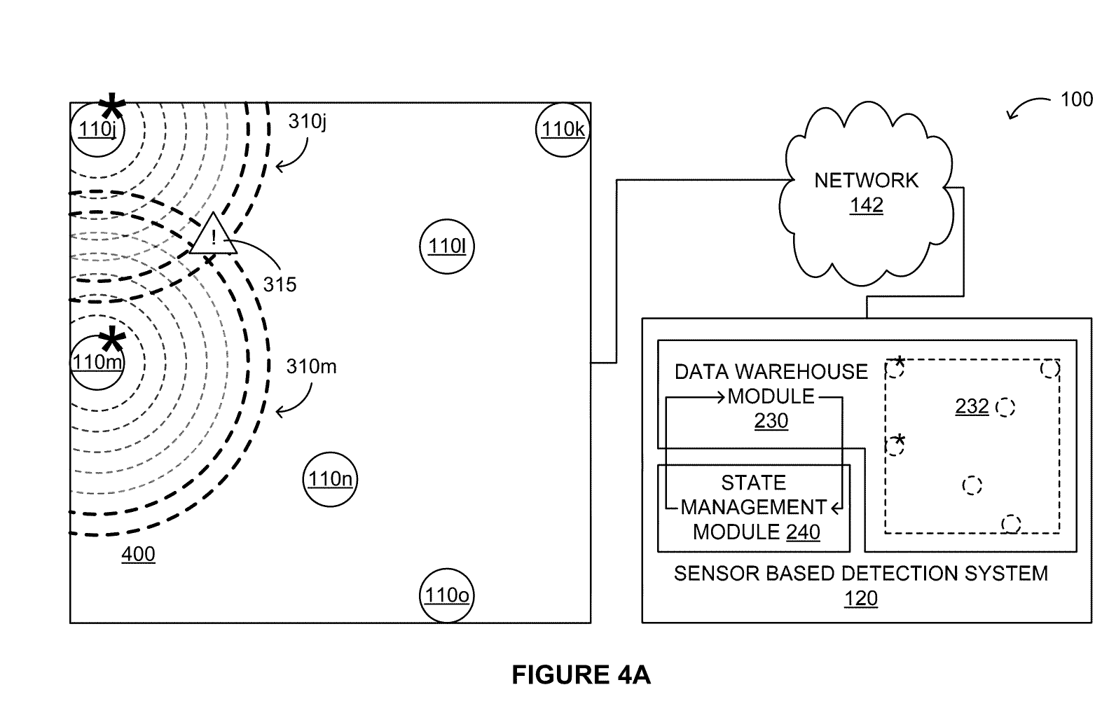

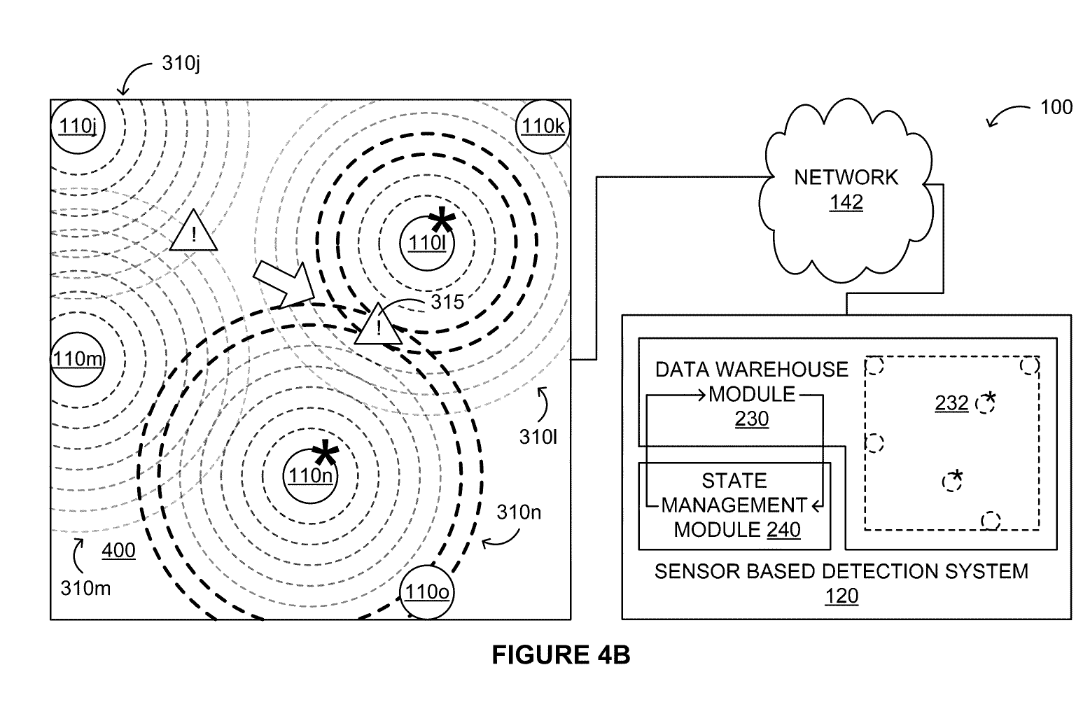

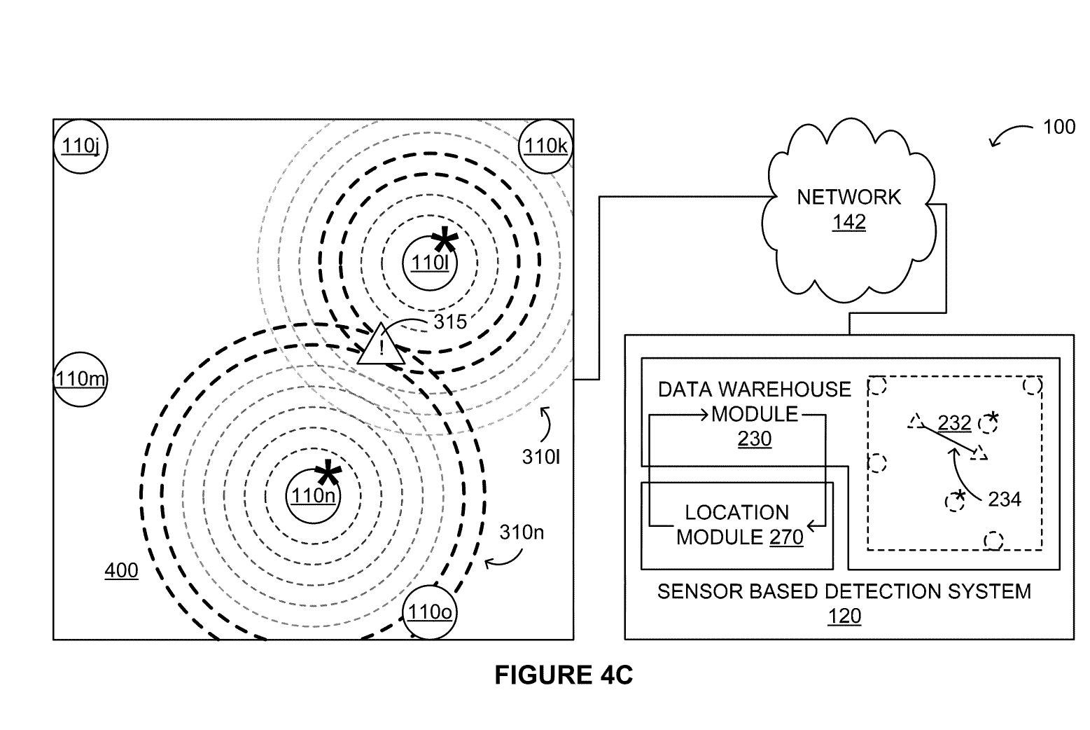

Adverting to FIG. 3A, the sensors 110 (e.g., sensors 110a-110i) of the system 100 may be arranged in an environment 300 such as one of the environments described herein. While the sensors 110 of FIG. 3A, as well as FIGS. 3B-3F, are regularly arranged in the environment 300, it is appreciated the foregoing is for an expository purpose, and the sensors 110 need not be regularly arranged as shown. (See FIGS. 4A and 4B.). In other words, the sensors 110 may be positioned in any fashion, for example, equidistant from one another, non-equidistant from one another, or any combination thereof.

A sensor of the sensors 110 may have an associated detection range, one of which is graphically illustrated in FIG. 3A as a detection range 310e for a sensor 110e. As shown by the heavier concentric lines of the detection range 310e at radii nearer to the sensor 110e and the lighter concentric lines of the detection range 310e at radii farther from the sensor 110e, a hazardous condition (e.g., a hazardous material emitting ionizing radiation) may be more strongly and/or more quickly detected at radii nearer to the sensor 110e than at radii farther from the sensor 110e. Such a detection range may vary in accordance with sensor sensitivity for one or more hazardous conditions. Outside of such a detection range, a hazardous condition may not be detected at all. It is appreciated that sensors may detect radially about a point or axis, as shown, or in a directional fashion (e.g., unidirectional, bidirectional, etc.). Accordingly, illustration of the detection ranges for the sensors are exemplary and not intended to limit the scope of the embodiments.

The sensors 110 of environment 300 may be communicatively connected to the sensor-based detection system 120 through the first network 142 as shown in FIG. 3A. As described herein, the data warehouse module 230 of the sensor-based detection system 120 may be configured for storing sensor readings and metadata (e.g., sensor description, geographical information, etc.) associated with the sensors 110. Such sensor readings and metadata for the sensors 110 may form a data structure associated with the data warehouse module 230, which is graphically depicted in FIG. 3A as data structure 232 in the data warehouse module 230.

Adverting to FIG. 3B, a sensor-based notification may occur when a hazardous condition 315 is located within the detection range of a sensor (e.g., the detection range 310e of the sensor 110e) and satisfies a certain condition (e.g., presence of a hazardous condition above a given threshold or within a certain range). The heavy concentric lines of the detection range 310e in FIG. 3B correspond to the radius at which the hazardous condition 315 is located within the detection range 310e for the sensor 110e. As described herein, the data warehouse module 230 may be configured to generate the sensor-based notification, or the state management module 240 may read data from the data warehouse module 230, determine whether a state change has occurred, and generate such a notification, for example, through the data warehouse module 230. The sensor-based notification for sensor 110e is depicted as an asterisk (*) for at least an elevated sensor reading in FIG. 3B in both the environment 300 and the data structure 232.

Adverting to FIG. 3C, a plurality of sensor-based notifications may occur when a hazardous condition 315 is located within the detection ranges of a plurality of sensors. While the hazardous condition 315 is equidistant from sensors 110a, 110b, 110d, and 110e, it is appreciated the foregoing is for an expository purpose, and the hazardous condition 315 need not be equidistant from the sensors 110a, 110b, 110d, and 110e in order to trigger a notification associated with those sensors. (See FIG. 3D.)

Each of the sensors 110a, 110b, 110d, and 110e may have an associated detection range, graphically illustrated in FIG. 3C as detection ranges 310a, 310b, 310d, and 310e, respectively, and the detection ranges may overlap in certain locations. However, it is appreciated that the detection ranges may not overlap in other embodiments. The plurality of sensor-based notifications may occur when the hazardous condition 315 is located within the detection ranges of the sensors 110a, 110b, 110d, and 110e. The heavy concentric lines of the detection ranges 310a, 310b, 310d, and 310e in FIG. 3C correspond to the radii at which the hazardous condition 315 is located within the detection ranges for the sensors 110a, 110b, 110d, and 110e. The plurality of sensor-based notifications for the sensors 110a, 110b, 110d, and 110e are depicted with asterisks (*) for at least elevated sensor readings in FIG. 3C in both the environment 300 and the data structure 232.

Adverting to FIG. 3D, the hazardous condition 315 may move or be moved from its initial or first position in FIG. 3C (or FIG. 3B) to a subsequent or second position in FIG. 3D. As shown, the second position of the hazardous condition 315 may be located at a different distance to each of the sensors 110a, 110b, 110d, and 110e.

The detection ranges 310a, 310b, 310d, and 310e respectively for the sensors 110a, 110b, 110d, and 110e may overlap in certain locations. However, the second position of the hazardous condition 315 may be located only within one or more of the foregoing detection ranges as depicted by the heavy concentric lines of the detection ranges 310d and 310e. As shown in FIG. 3D, the hazardous condition 315 is located only within the detection ranges 310d and 310e respectively for the sensors 110d and 110e. In less densely sensored environments, the second position of the hazardous condition 315 may be outside the detection range of any of a plurality of sensors such as between two or more detection ranges of the plurality of sensors.

In the first position of the hazardous condition 315 shown in FIG. 3C, the plurality of sensor-based notifications corresponding to the sensors 110a, 110b, 110d, and 110e are expected to have the same quality (e.g., elevated sensor readings with respect to the hazard) for the same sensors having the same sensitivities on account of the hazardous condition 315 being equidistant from the sensors. In the second position of the hazardous condition 315 shown in FIG. 3D, the plurality of sensor-based notifications corresponding to the sensors 110a, 110b, 110d, and 110e may have different qualities for the same sensors having the same sensitivities on account of the hazardous condition 315 being at a different distance to each of the sensors. For example, the hazardous condition 315 may be outside the detection ranges 310a and 310b respectively for the sensors 110a and 110b. As such, the sensors 110a and 110b are depicted without asterisks for hazard-free sensor readings in FIG. 3D in both the environment 300 and the data structure 232. However, the hazardous condition 315 may be within the detection ranges 310d and 310e respectively for the sensors 110d and 110e. As such, the sensors 110d and 110e are depicted with asterisks (*) for at least elevated sensor readings in FIG. 3D in both the environment 300 and the data structure 232. Due to the hazardous condition 315 being farther from the sensor 110d than the sensor 110e, the hazardous condition 315 may induce sensor-based notifications having different qualities for the same sensors 110d and 110e having the same sensitivities. For example, the senor-based notification for sensor 110d may be elevated with respect to the hazardous condition 315, while the senor-based notification for sensor 110e may be a warning with respect to the hazardous condition 315. In other embodiments, the actual reading values may be used as the notification, thereby a notification from the sensor 110e would have a higher value in one instance illustrating a higher reading in comparison to the sensor 110d that has a lower reading value by virtue of being located further away from the hazardous condition 315.

Adverting to FIG. 3E, the hazardous condition 315 may move or be moved from the second position in FIG. 3D to a third position in FIG. 3E. As shown, the third position of the hazardous condition 315 may be located at a different distance to each of the sensors 110d, 110e, 110f, and 110h.

The detection ranges 310d, 310e, 310f, and 310h respectively for the sensors 110d, 110e, 110f, and 110h may overlap in certain locations. However, the third position of the hazardous condition 315 may be located only within one or more of the foregoing detection ranges as depicted by the heavy concentric lines of the detection ranges 310e. As shown in FIG. 3E, the hazardous condition 315 is located only within the detection range 310e for the sensor 110e.

In the third position of the hazardous condition 315 shown in FIG. 3E, the plurality of sensor-based notifications corresponding to the sensors 110d, 110e, 110f, and 110h may have different qualities for the same sensors having the same sensitivities on account of the hazardous condition 315 being at a different distance to each of the sensors. For example, the hazardous condition 315 may be outside the detection ranges 310d, 310f, and 310h respectively for the sensors 110d, 110f, and 110h. As such, the sensors 110d, 110f, and 110h are depicted without asterisks for hazard-free sensor readings in FIG. 3E in both the environment 300 and the data structure 232. However, the hazardous condition 315 may be within the detection range 310e for the sensor 110e. As such, the sensor 110e is depicted with an asterisk (*) for at least an elevated sensor reading in FIG. 3E in both the environment 300 and the data structure 232. Due to the hazardous condition 315 being close to the sensor 110e, the hazardous condition 315 may induce a sensor-based notification including a warning with respect to the hazardous condition 315.

Adverting to FIG. 3F, the sensor-based notifications having different qualities or strengths described in reference to FIGS. 3C-E may provide differentiating information or weighted information for spatial analysis of the hazardous condition 315 with respect to the sensors 110 at any desired instance of time or interval of time, which information may be stored in data structure 232 in the data warehouse module 230 for spatial analysis. As described herein, the location module 270 may be configured for such spatial analysis (e.g., triangulation). As shown, the location module 270 and the data warehouse module 230 may be configured to operate in concert to determine a path for the hazardous condition 315 over an interval of time, which is graphically depicted in FIG. 3F as path 234 associated with data structure 232. It is appreciated that the information depicted graphically is for illustrative purposes only and need not be rendered on a display. For rendering the information graphically, the analyzed information by the location module 270 and/or the data warehouse module 230 may be transmitted to the visualization module 250 for rendering (e.g., on a display). In some embodiments, the path 234 of the hazardous condition 315 may be provided to an output system directly connected to sensor-based detection system 120 or the output system 130 for processing into a human-comprehendible form (e.g., text, graphic, video, audio, a tactile form such as vibration, etc.).

Adverting to FIG. 4A, the sensors 110 (e.g., sensors 110j-110o) of the system 100 may be arranged in an environment 400 such as one of the environments described herein. Unlike the sensors 110 of FIG. 3A, the sensors 110 of FIG. 4A are irregularly arranged in the environment 400. It is appreciated the arrangement of the sensors depends upon the environment in which the sensors are deployed and the sensor-based coverage desired therefor.

A plurality of sensor-based notifications may occur when a hazardous condition 315 is located within the detection ranges of a plurality of sensors. Each of the sensors 110j and 110m may have an associated detection range, graphically illustrated in FIG. 4A as detection ranges 310j and 310m, respectively, and the detection ranges may overlap in certain locations. The plurality of sensor-based notifications may occur when the hazardous condition 315 is located within the detection ranges of the sensors 110j and 110m. The heavy concentric lines of the detection ranges 310j and 310m in FIG. 4A correspond to the radii at which the hazardous condition 315 is located within the detection ranges for the sensors 110j and 110m. The plurality of sensor-based notifications for the sensors 110j and 110m are depicted with asterisks (*) for at least elevated sensor readings in FIG. 4A in both the environment 400 and the data structure 232.

Adverting to FIG. 4B, the hazardous condition 315 may move or be moved from its initial or first position in FIG. 4A to a subsequent or second position in FIG. 4B. As shown, the second position of the hazardous condition 315 may be located at a different distance to each of the sensors 110j, 110l, 110m, and 110n.

The detection ranges 310j, 3101, 310m, and 310n respectively for the sensors 110j, 110l, 110m, and 110n may overlap in certain locations. However, the second position of the hazardous condition 315 may be located only within one or more of the foregoing detection ranges as depicted by the heavy concentric lines of the detection ranges 310l and 310n. As shown in FIG. 4B, the hazardous condition 315 is located only within the detection ranges 310l and 310n respectively for the sensors 110l and 110n. In less densely sensored environments, the second position of the hazardous condition 315 may be outside the detection range of any of a plurality of sensors such as between two or more detection ranges of the plurality of sensors.

In the first position of the hazardous condition 315 shown in FIG. 4A, the plurality of sensor-based notifications corresponding to the sensors 110j and 110m may have the same quality (e.g., elevated sensor readings with respect to the hazard) or different qualities on account of the hazardous condition 315 being at the same distance or different distances to each of the respective sensors, which sensors may have the same sensitivities. In the second position of the hazardous condition 315 shown in FIG. 4B, the plurality of sensor-based notifications corresponding to the sensors 110j, 110l, 110m, and 110n may have different qualities for the same sensors having the same sensitivities on account of the hazardous condition 315 being at different distances to each of the respective sensors. For example, the hazardous condition 315 may be outside the detection ranges 310j and 310m respectively for the sensors 110j and 110m. As such, the sensors 110j and 110m are depicted without asterisks for hazard-free sensor readings in FIG. 4B in both the environment 400 and the data structure 232. However, the hazardous condition 315 may be within the detection ranges 310l and 310n respectively for the sensors 110l and 110n. As such, the sensors 110l and 110n are depicted with asterisks (*) for at least elevated sensor readings in FIG. 4B in both the environment 400 and the data structure 232. Due to the hazardous condition 315 being closer to the sensor 110l than the sensor 110n, the hazardous condition 315 may induce sensor-based notifications having different qualities for the sensors 110l and 110n, which sensors may have the same sensitivities. For example, the senor-based notification for sensor 110l may be a warning with respect to the hazardous condition 315, while the senor-based notification for sensor 110n may be elevated with respect to the hazardous condition 315.

Adverting to FIG. 4C, the sensor-based notifications having different qualities described in reference to FIGS. 4A and 4B may provide differentiating information or weighted information for spatial analysis of the hazardous condition 315 with respect to the sensors 110 at any desired instance of time or interval of time. As described herein, the location module 270 may be configured for such spatial analysis (e.g., triangulation). As shown, the location module 270 and the data warehouse module 230 may be configured to operate in concert to determine a path for the hazardous condition 315 over an interval of time, which is depicted in FIG. 4C as path 234 associated with data structure 232. The path 234 of the hazardous condition 315 may be provided to an output system directly connected to sensor-based detection system 120 or the output system 130 for processing into a human-comprehendible form (e.g., text, graphic, video, audio, a tactile form such as vibration, etc.).

It is appreciated that the sensors 110a-110i of FIGS. 3A-3F and the sensors 110j-110o of FIGS. 4A-4C are each described as having the same sensors with the same sensitivities for an expository purpose. As such, it is appreciated that different sensors having different sensitivities may be used in some embodiments.

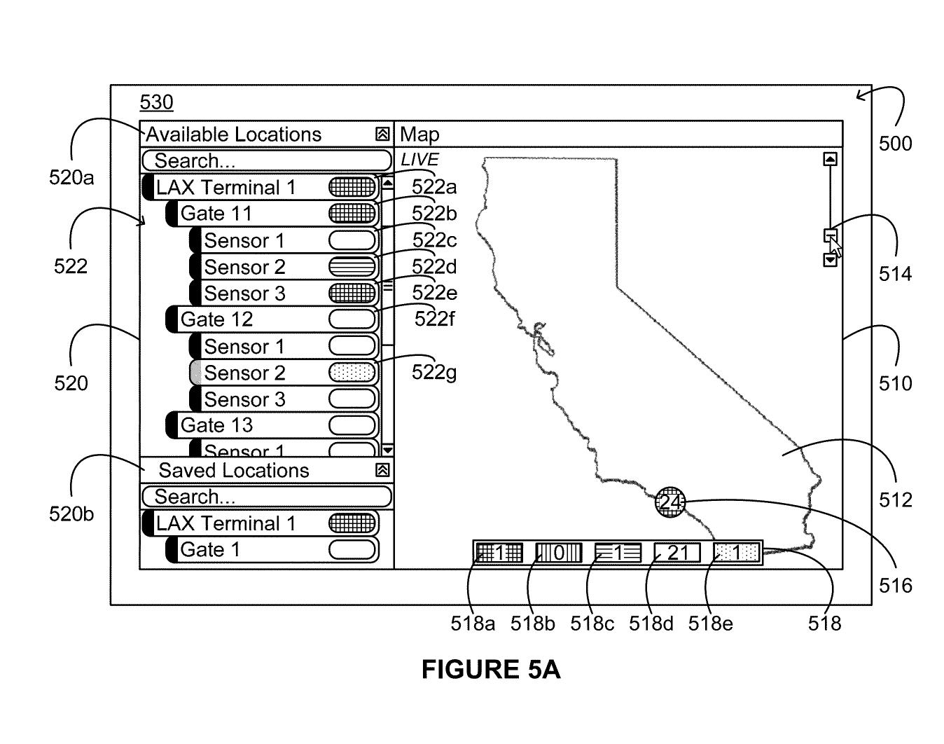

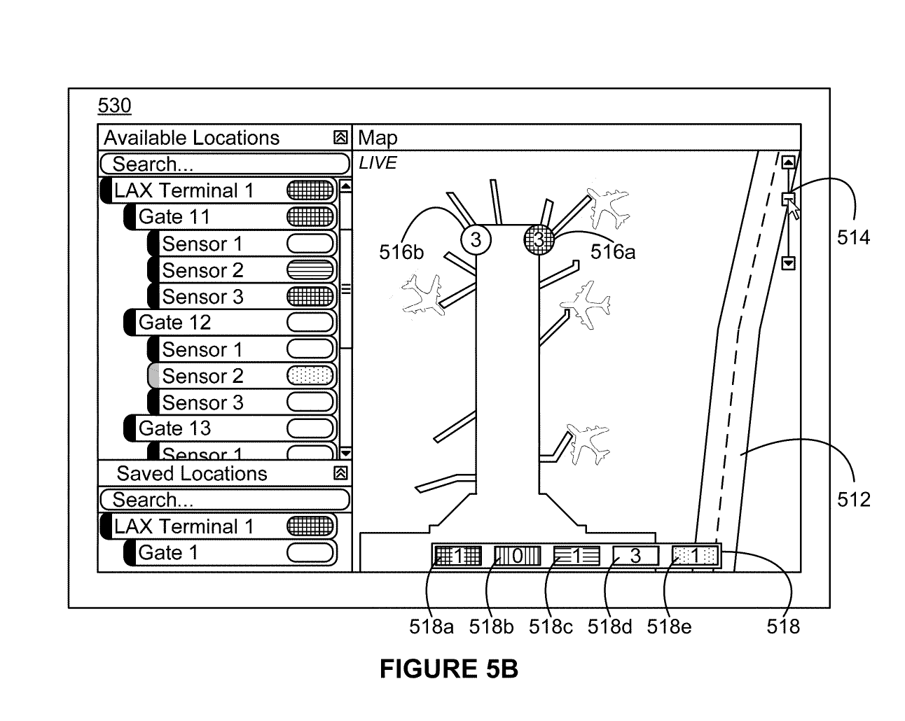

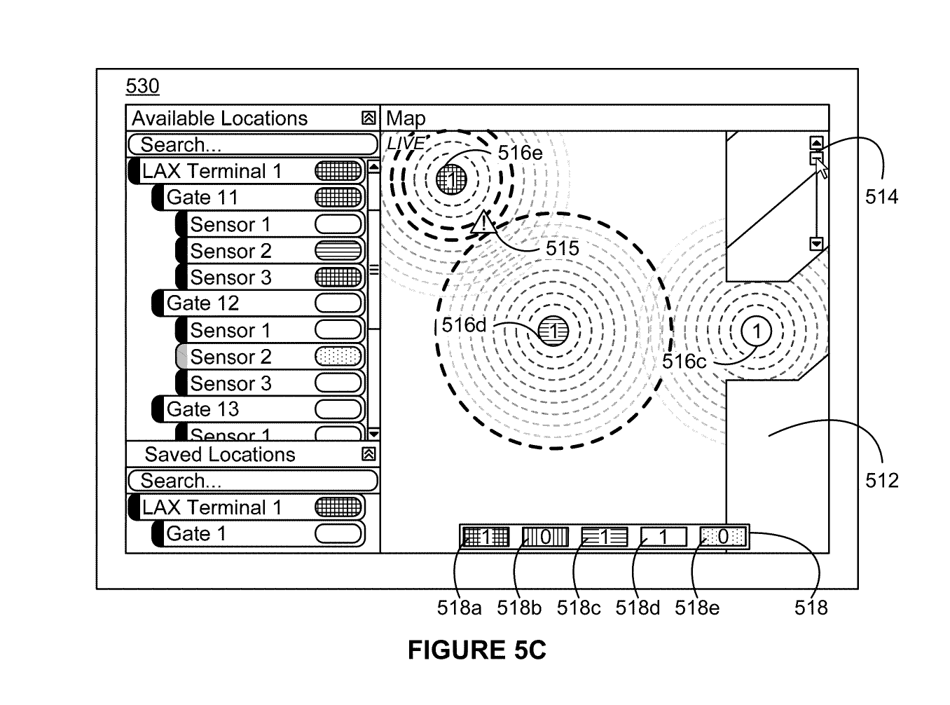

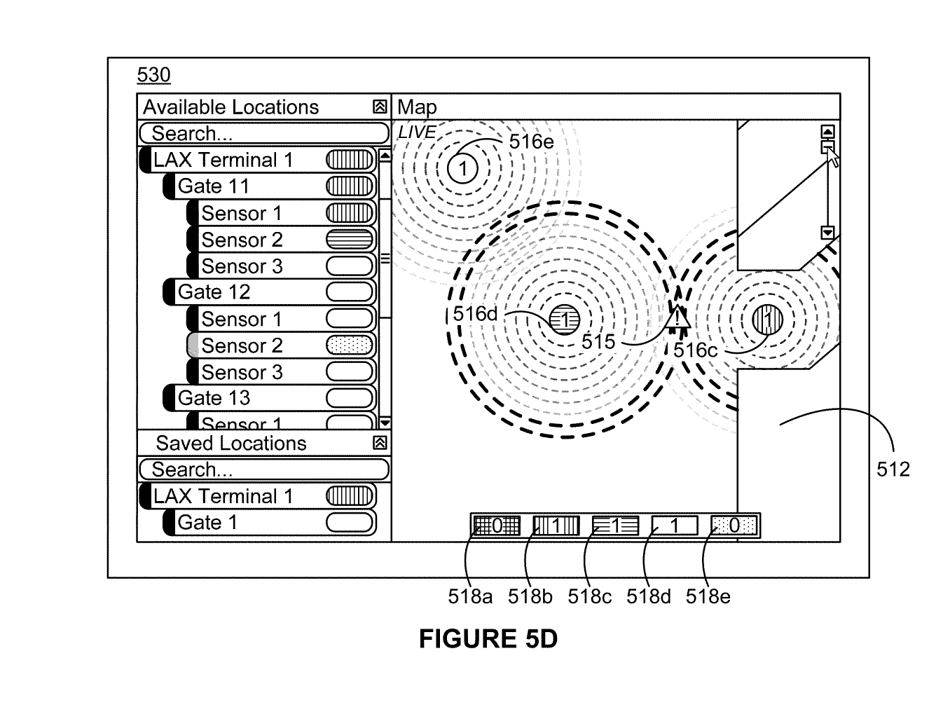

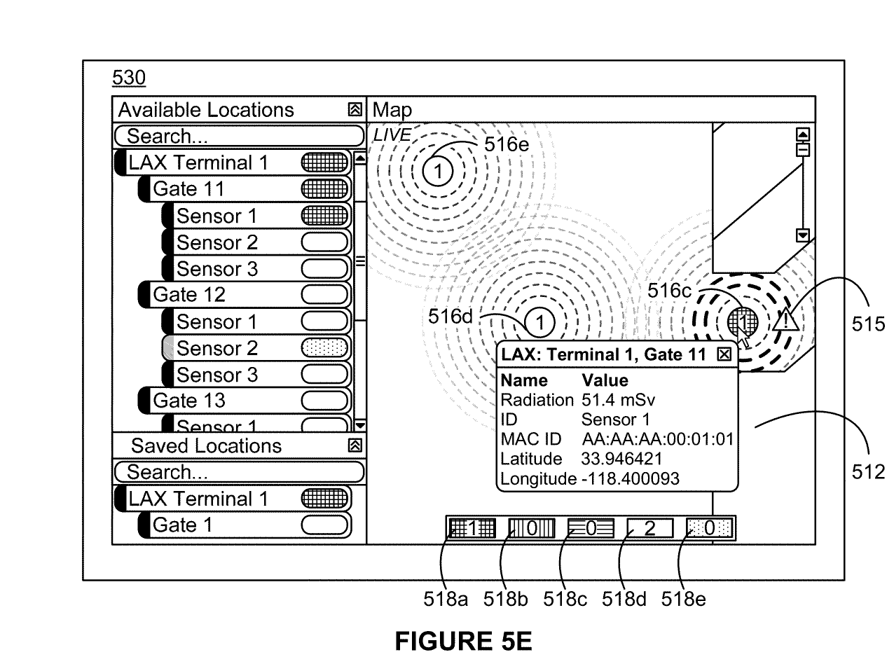

The sensor-based detection system 120 may include a directly connected output system (e.g., a directly connected display), or the sensor-based detection system 120 may utilize the output system 130 (e.g., a networked display), any of which may be operable to render a GUI for monitoring and/or managing the sensors 110. As described herein, the visualization module 250 may provide the GUI or the information therefor. Such a GUI is shown in FIGS. 5A-5E, 6A-6C, 7A, and 7B as GUI 500 on display 530. While the GUI 500 shown in each FIGS. 5A-5E, 6A-6C, 7A, and 7B has a certain layout with certain elements, it is appreciated the foregoing is for an expository purpose, and the GUI 500 need not be as shown in FIGS. 5A-5E, 6A-6C, 7A, and 7B.

Adverting to FIG. 5A, the GUI 500 may include, but is not limited to, a map pane 510 and a location pane 520. The map pane 510 and the location pane 520 may be displayed individually or together as shown. In addition, any one of the map pane 510 or the location pane 520, or both, may be combined with other GUI structural elements as desired for monitoring and/or managing the sensors 110. Such other GUI structural elements include, but are not limited to, GUI structural elements selected from windows such as container windows, child windows, dialog boxes, property windows, message windows, confirmation windows, browser windows, text terminal windows, etc.; controls or widgets such as balloons, buttons (e.g., command buttons), links (e.g., hyperlinks), drop-down lists, combo boxes, group boxes, check boxes, list boxes, list views, notifications, progress bars, progressive disclosure controls, radio buttons, search boxes, sliders, spin controls, status bars, tabs, text boxes, tool tips, info tips, tree views, data grids, etc.; commands such as menus (e.g., menu bars, context menus, menu extras), toolbars, ribbons, etc.; and visuals such as icons, pointers, etc.

With respect to the map pane 510, the map pane 510 may include a map 512 generated by a geographical information system (GIS) on which a graphical representation of one or more of the sensors 110 may be present.

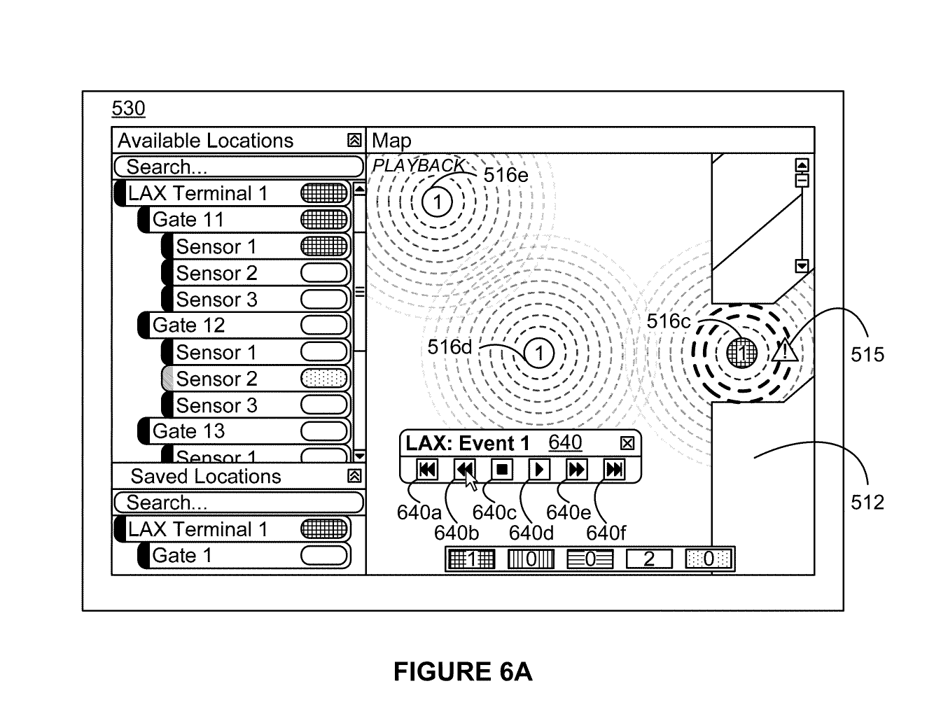

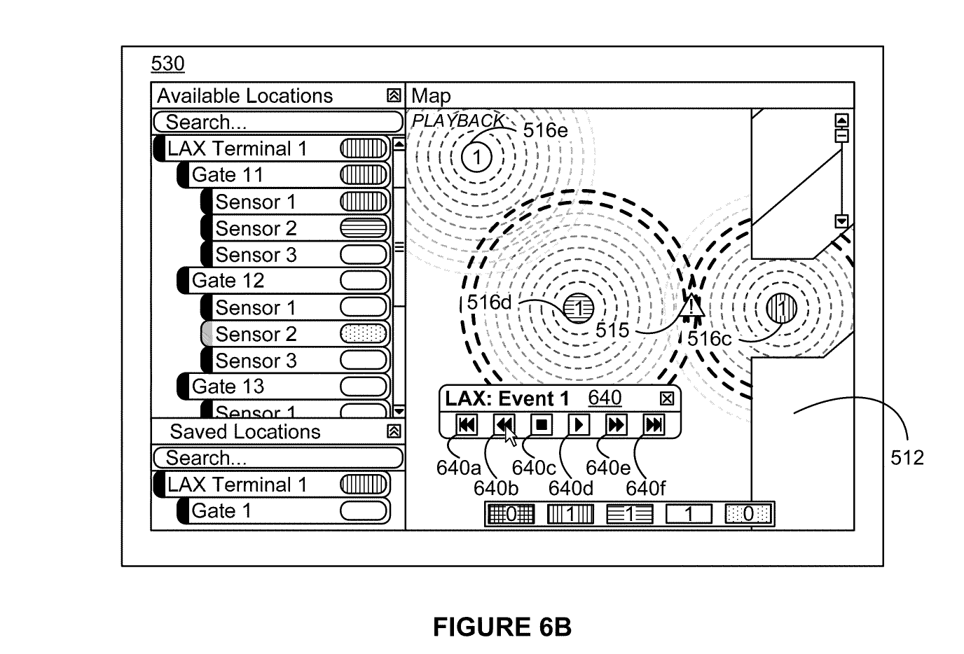

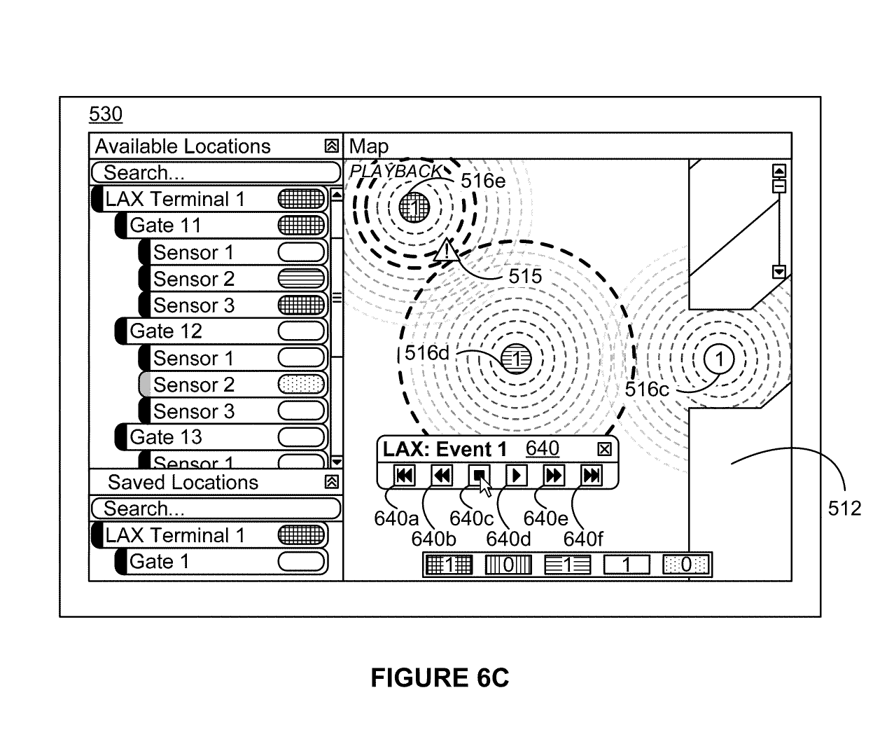

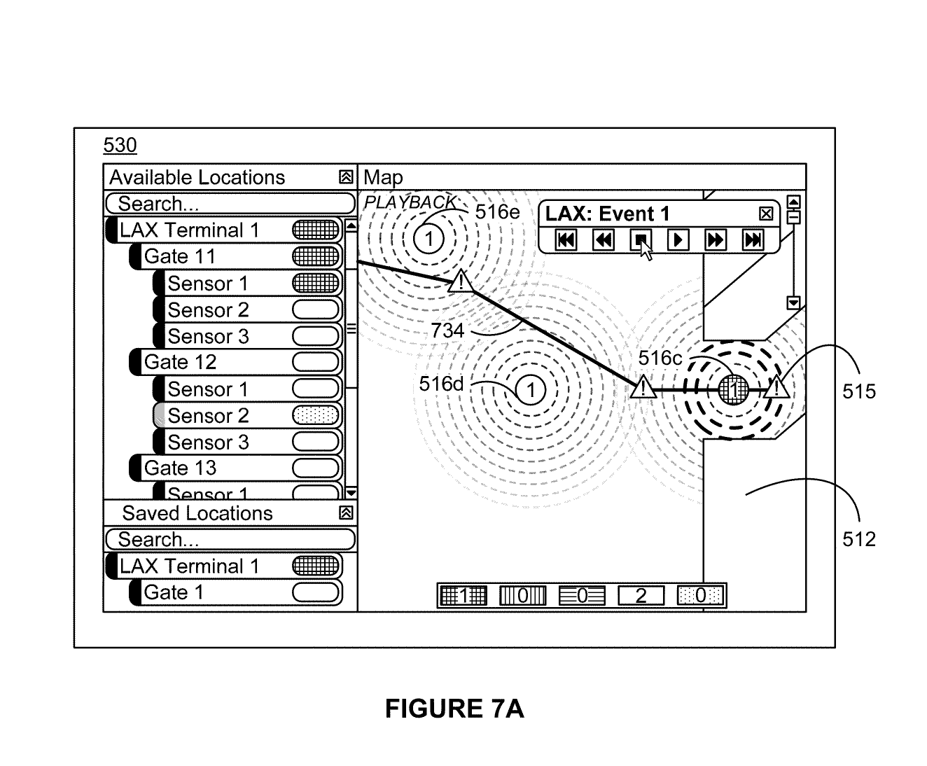

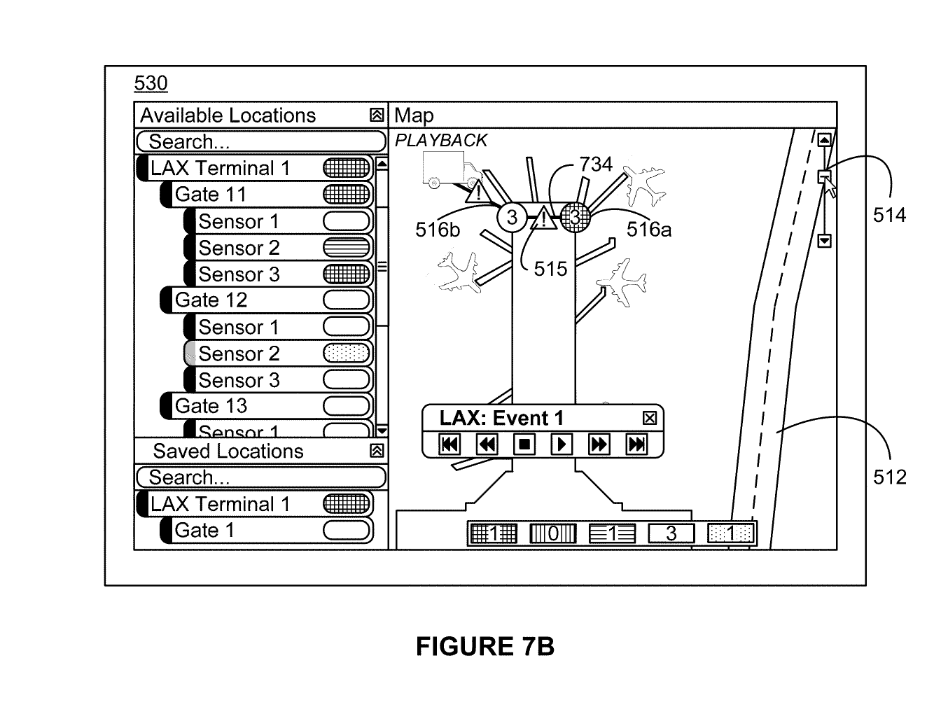

The map 512 may be a real-time or live map, or the map 512 may be an historical map. A live map is shown in FIG. 5A as indicated by “LIVE” in the top, left-hand corner of the map 512. An historical map is shown in FIGS. 6A-6C, 7A, and 7B as indicated by “PLAYBACK” in the top, left-hand corner of the map 512 in FIGS. 6A-6C, 7A, and 7B. It is appreciated that “LIVE” and “PLAYBACK” are used for an expository purpose, and the live or historical status of the map 512 need not be respectively indicated by “LIVE” and “PLAYBACK.”

The map 512 may include different zoom levels including different levels of detail. The zoom level may be adjusted using a zoom level control. Such a zoom level control is shown as zoom level control 514 in FIG. 5A. The zoom level may range from a view from above the Earth to a view from inside a room of a building or a similar, human-sized scale. The map 512 of FIG. 5A depicts an intermediate zoom level providing a level of detail important for monitoring and/or managing sensors over the state of California.

A graphical representation of the one or more of the sensors 110 is shown in FIG. 5A as sensor representation 516. The sensor representation 516 may indicate one sensor at a human-sized scale (e.g., a room of a building), or the sensor representation 516 may indicate one sensor or a cluster of two or more sensors at a larger scale (e.g., a building). The sensor representation 516 depicted in FIG. 5A indicates a cluster of twenty four sensors at LAX on a California state-sized scale. While other sensors may be present on the California state-sized scale, the cluster of sensors depicted in FIG. 5A may represent a user selection for the cluster. Such a user selection may result from selecting (e.g., clicking) the sensor representation 516 for the cluster at the California state-sized scale, for example, on the basis of a warning reading with respect to one or more hazards. Such a user selection may alternatively result from choosing a saved location (e.g., LAX) in the location pane 520 or searching (e.g., searching for LAX) in the location pane 520.

When the sensor representation 516 represents one sensor, the sensor representation 516 may indicate the sensor reading (e.g., normal, elevated, potential warning, and warning readings with respect to one or more hazards) for the one sensor. When the sensor representation 516 represents a cluster of two or more sensors, the sensor representation 516 may indicate the highest sensor reading for the cluster. As such, because at least one sensor represented by the sensor representation 516 in FIG. 5A indicates a warning with respect to one or more hazards, the sensor representation 516, which represents twenty four sensors, indicates the warning. Alternatively, the sensor representation 516 may indicate the average sensor reading for the cluster.

The map 512 may include a sensor filter 518 providing a visual indicator useful for identifying sensor readings (e.g., normal, elevated, potential warning, and warning readings with respect to one or more hazards) for one or more sensors at a glance. The sensor filter 518 may also provide a means for selecting one or more sensors by like sensor readings (e.g., all sensors with warning readings with respect to one or more hazards may be selected). The sensor filter 518 may correspond to one or more sensor representations such as the sensor representation 516. As such, the sensor filter 518 may correspond to one sensor, or the sensor filter 518 may correspond to a cluster of two or more sensors at a larger scale (e.g., a building), which may be defined by zoom level manipulation, active user selection, or the like, as described herein. The sensor filter 518 depicted in FIG. 5A indicates the same cluster of twenty four sensors at LAX depicted by the sensor representation 516.

The filter sensor 518 of FIG. 5A may include a first filter sensor element 518a, a second filter sensor element 518b, a third filter sensor element 518c, a fourth filter sensor element 518d, and a fifth filter sensor element 518e, each of which may indicate a different sensor reading (e.g., calibrating or a normal, elevated, potential warning, or warning reading with respect to one or more hazards), and each of which may indicate the total number of sensors in a cluster of sensor having the different sensor reading. For example, the first filter sensor element 518a of FIG. 5A indicates one sensor of the cluster of twenty four sensors at LAX has a warning reading with respect to one or more hazards; the second filter sensor element 518b indicates no sensor of the cluster has an elevated reading with respect to one or more hazards; the third filter sensor element 518c indicates one sensor of the cluster has a potential warning reading with respect to one or more hazards; the fourth filter sensor element 518d indicates twenty one sensors of the cluster have a normal reading with respect to one or more hazards; and the fifth filter sensor element 518e indicates one sensor of the cluster is calibrating.

With respect to the location pane 520, the location pane 520 may include, but is not limited to, a first location sub-pane 520a and a second location sub-pane 520b, wherein the first location sub-pane 520a includes available locations for monitoring and/or managing sensors, and wherein the second location sub-pane 520b includes saved locations (e.g., favorite locations) for monitoring and/or managing sensors. Additional sub-panes may include additional groupings of locations. The first and second location sub-panes may include indicators 522 (e.g., 522a-522g). It is appreciated that the indicators 522 change in response to zoom level manipulation, active user selection, or the like, as described herein. As shown in FIG. 5A, the indicators 522 correspond to the same cluster of twenty four sensors at LAX depicted by the sensor representation 516. The first and second location sub-panes may further include search boxes for finding one or more indicators 522.

In some embodiments, the indicators 522 may be arranged in a hierarchical relationship in the location pane 520. As shown, indicator 522a, which is titled “LAX Terminal 1,” is the indicator for Terminal 1 of LAX; indicator 522b, which is titled “Gate 11,” is the indicator for Gate 11 of Terminal 1 of LAX; and indicators 522c, 522d, and 522e, which are titled, “Sensor 1,” “Sensor 2,” and “Sensor 3,” respectively, are the indicators for Sensors 1-3 of Gate 11 of Terminal 1 of LAX. As such, the indicator 522a (“LAX Terminal 1”) is a parent indicator of the indicator 522b (“Gate 11”), and the indicator 522b is a parent indicator of the indicators 522c (“Sensor 1”), 522d (“Sensor 2”), and 522e (“Sensor 3”). The indicators 522c (“Sensor 1”), 522d (“Sensor 2”), and 522e (“Sensor 3”) may also be described as children indicators of the indicator 522b (“Gate 11”), and the indicator 522b may be described as a child indicator of the indicator 522a (“LAX Terminal 1”). It is appreciated that an indicator for LAX (not shown as scrolled out of view) is a parent indicator of the indicator 522a (“LAX Terminal 1”).

When an indicator represents one sensor, the indicator may indicate the sensor reading (e.g., normal, elevated, potential warning, and warning readings with respect to one or more hazards) for the one sensor. For example, indicator 522e (“Sensor 3”) may indicate a warning from a sensor with respect to one or more hazards because indicator 522e indicates only one sensor, optionally as further indicated by filter sensor 518a. When an indicator represents a cluster of two or more sensors, the indicator may indicate the highest sensor reading for the cluster. For example, indicator 522b (“Gate 11”) indicates a warning from three sensors (e.g., the three sensors represented by indicators 522c-522e) with respect to one or more hazards. Likewise, indicator 522a (“LAX Terminal 1”) indicates a warning from a plurality of sensors (e.g., the sensors represented by indicators hierarchically below indicator 522a) with respect to one or more hazards. Alternatively, when an indicator represents a cluster of two or more sensors, the indicator may indicate the average sensor reading for the cluster.

The indicators 522 may be associated with a different sensor reading (e.g., normal, elevated, potential warning, and warning readings with respect to one or more hazards) in accordance with the hierarchical relationship. For example, the indicator 522a of FIG. 5A indicates at least one sensor of the cluster of sensors in Terminal 1 of LAX has a warning reading with respect to one or more hazards, as further optionally indicated by correspondence with filter element 518a. The indicator 522b indicates at least one sensor of the cluster of sensors in Gate 1 of Terminal 1 of LAX has a warning reading with respect to one or more hazards, as further optionally indicated by correspondence with filter element 518a. The indicator 522c indicates Sensor 1 of Gate 1 of Terminal 1 of LAX has a normal reading with respect to one or more hazards, as further optionally indicated by correspondence with filter element 518c. The indicator 522d indicates Sensor 2 of Gate 1 of Terminal 1 of LAX has a potential warning reading with respect to one or more hazards, as further optionally indicated by correspondence with filter element 518c. And the indicator 522e indicates Sensor 3 of Gate 1 of Terminal 1 of LAX has a warning reading with respect to one or more hazards, as further optionally indicated by correspondence with filter element 518a. Indicator 522g indicates a calibrating sensor. Because a calibrating sensor is not a hazard-related sensor reading (e.g., normal, elevated, potential warning, and warning readings with respect to one or more hazards), a calibrating sensor is not indicated hierarchically above its respective indicator. However, the calibrating sensor may be indicated hierarchically above its respective indicator as desired.

Adverting to FIG. 5B, the zoom level of the map 512 may be adjusted with the zoom level control 514 as described herein. For example, the zoom level of the map may be adjusted from the California state-sized scale shown in FIG. 5A to the scale shown in FIG. 5B, which depicts Terminal 1 of LAX. While the sensor representation 516 depicted in FIG. 5A indicates a cluster of twenty four sensors at LAX on a California state-sized scale, sensor representations 516a and 516b of FIG. 5B indicate a first cluster of three sensors at Gate 11 and a second cluster of three sensors at Gate 12. As described herein, other sensors may be present; the clusters of sensors depicted in FIG. 5B may represent a user selection for the clusters. It is appreciated that the number of sensors shown are for illustrative purposes and the number of sensors should not be construed as limiting the scope of the embodiments.

The sensor filter 518 may automatically adjust to match the zoom level of the map 512 and/or the user selection for the clusters in the map 512. While the sensor filter 518 depicted in FIG. 5A indicates a cluster of twenty four sensors at LAX on a California state-sized scale, the sensor filter 518 of FIG. 5B indicates a cluster of six sensors at Gates 11 and 12 of Terminal 1 of LAX. With respect to the cluster of six sensors, the first filter sensor element 518a of FIG. 5B indicates one sensor of the cluster has a warning reading with respect to one or more hazards, likely at Gate 11 of Terminal 1. The second filter sensor element 518b indicates no sensor of the cluster has an elevated reading with respect to one or more hazards. The third filter sensor element 518c indicates one sensor of the cluster has a potential warning reading with respect to one or more hazards, also likely at Gate 11 of Terminal 1. The fourth filter sensor element 518d indicates three sensors of the cluster have a normal reading with respect to one or more hazards. And the fifth filter sensor element 518e indicates one sensor of the cluster is calibrating.

While the location pane 520 may automatically adjust to match the zoom level of the map 512 and/or the user selection for the clusters in the map 512, the location pane 520 may be operated individually as shown between FIGS. 5A and 5B.

Adverting to FIG. 5C, the zoom level of the map 512 may be further adjusted with the zoom level control 514. For example, the zoom level of the map may be adjusted from the scale shown in FIG. 5B to the scale shown in FIG. 5C, which depicts Gate 11 of Terminal 1 of LAX. While the sensor representations 516a and 516b depicted in FIG. 5B indicate a first cluster of three sensors at Gate 11 and a second cluster of three sensors at Gate 12, each of sensor representations 516c, 516d, and 516e depicted in FIG. 5C indicate a single sensor in a different location of Gate 11 of Terminal 1 of LAX. As described herein, other sensors may be present; the sensors depicted in FIG. 5C may represent a user selection for the sensors.

The sensor filter 518 may automatically adjust to match the zoom level of the map 512 and/or the user selection for the sensors in the map 512. While the sensor filter 518 depicted in FIG. 5B indicates a cluster of six sensors at Gates 11 and 12 of Terminal 1 of LAX, the sensor filter 518 of FIG. 5C indicates a cluster of three sensors at Gate 11 of Terminal 1 of LAX. With respect to the cluster of three sensors, the first filter sensor element 518a of FIG. 5C indicates one sensor of the cluster has a warning reading (e.g., as represented by sensor representation 516e) with respect to one or more hazards including a hazardous condition 515, which hazardous condition may or may not be displayed in the GUI; the second filter sensor element 518b indicates no sensor of the cluster has an elevated reading with respect to one or more hazards; the third filter sensor element 518c indicates one sensor of the cluster has a potential warning reading (e.g., represented by sensor representation 516d) with respect to one or more hazards including the hazardous condition 515; the fourth filter sensor element 518d indicates one sensor of the cluster has a normal reading (e.g., represented by sensor representation 516c) with respect to one or more hazards; and the fifth filter sensor element 518e indicates no sensor of the cluster is calibrating. It is appreciated that while detection ranges (e.g., as described in reference to FIGS. 3A-3F and FIGS. 4A-4C) are graphically illustrated in FIG. 5C for the sensor representations 516c, 516d, and 516e, as well as in FIGS. 5D, 5E, 6A-6C, 7A, and 7B for their respective sensor representations, the detection ranges are for an expository purpose and need not be displayed in the GUI.

Adverting to FIG. 5D, the zoom level of the map 512 may be maintained, and the map 512 may be monitored in real-time, as indicated by “LIVE” in the top, left-hand corner of the map 512. It is appreciated that “LIVE” is used for an expository purpose, and the live status of the map 512 need not be indicated by “LIVE” in the GUI.

While the hazardous condition 515 of FIG. 5C is depicted in a position between the sensors represented by sensor representations 516d and 516e, the hazardous condition 515 of FIG. 5D is depicted as having moved into a position between the sensors represented by sensor representations 516c and 516d. Consequently the sensor filter 518 of FIG. 5D is depicted as having changed with respect to the sensor filter 518 of FIG. 5C. The sensor filter 518 of FIG. 5D still indicates the cluster of three sensors at Gate 11 of Terminal 1 of LAX. However, the first filter sensor element 518a of FIG. 5D indicates no sensor of the cluster has a warning reading with respect to one or more hazards; the second filter sensor element 518b indicates one sensor of the cluster has an elevated reading (e.g., as represented by sensor representation 516c) with respect to one or more hazards including the hazardous condition 515, which hazardous condition may or may not be displayed in the GUI; the third filter sensor element 518c indicates one sensor of the cluster has a potential warning reading (e.g., represented by sensor representation 516d) with respect to one or more hazards including the hazardous condition 515; the fourth filter sensor element 518d indicates one sensor of the cluster has a normal reading (e.g., represented by sensor representation 516e) with respect to one or more hazards; and the fifth filter sensor element 518e indicates no sensor of the cluster is calibrating.

Adverting to FIG. 5E, the map 512 may be further monitored in real-time. While the hazardous condition 515 of FIG. 5D is depicted in a position between the sensors represented by sensor representations 516c and 516d, the hazardous condition 515 of FIG. 5E is depicted as having moved into a new position near the sensor represented by sensor representation 516c. Consequently the sensor filter 518 of FIG. 5E is depicted as having changed with respect to the sensor filter 518 of FIG. 5D. The sensor filter 518 of FIG. 5E still indicates the cluster of three sensors at Gate 11 of Terminal 1 of LAX. However, the first filter sensor element 518a of FIG. 5D indicates one sensor of the cluster has a warning reading (e.g., as represented by sensor representation 516c) with respect to one or more hazards including the hazardous condition 515, which hazardous condition may or may not be displayed in the GUI; the second filter sensor element 518b indicates no sensor of the cluster has an elevated reading with respect to one or more hazards; the third filter sensor element 518c indicates no sensor of the cluster has a potential warning reading with respect to one or more hazards; the fourth filter sensor element 518d indicates two sensors of the cluster have a normal reading (e.g., represented by sensor representations 516d and 516e) with respect to one or more hazards; and the fifth filter sensor element 518e indicates no sensor of the cluster is calibrating.

Live or historical sensor readings and metadata corresponding to any sensor may be displayed using any of a number of user selections including, but not limited to, selecting (e.g., clicking) an indicator (e.g., indicator 522e of FIG. 5A), a filter sensor element (e.g., filter sensor element 518a of FIG. 5E), and a sensor representation (e.g., sensor representation 516c). For example, a user may select a sensor representation such as sensor representation 516c of FIG. 5E to display sensor readings and metadata corresponding to the sensor represented by sensor representation 516c. As shown, the sensor readings may include a measure of ionizing radiation (e.g., 51.4 mSv), and the sensor metadata may include the sensor identification (e.g., Sensor 1), the sensor's media access control (MAC) address (e.g., AA:AA:AA:00:01:01), and the sensor's latitude (e.g., 33.946421) and longitude (e.g., −118.400093). However, it is appreciated that the foregoing is used for an expository purpose, and a sensor's readings and metadata need not include the foregoing or be limited to the foregoing.

Adverting to FIGS. 6A-6C, the map 512 may be historically reviewed as indicated by “PLAYBACK” in the top, left-hand corner of the map 512 in FIGS. 6A-6C, as well as FIGS. 7A, and 7B. It is appreciated that “PLAYBACK” is used for an expository purpose, and the historical status of the map 512 need not be indicated by “PLAYBACK.”

The GUI may be operable to include a playback control 640 for historical sensor readings and metadata, which may be useful for reviewing current or past events (e.g., one or more sensor readings satisfying a certain condition such as a hazardous condition above a given threshold or within a certain range) from its beginning (e.g., t₀) or any other desired time (e.g., t₁, t₂, t₃, etc.) to real time. As shown, playback control 640 may include, but is not limited to, a discrete rewind button 640a for rewinding by a discrete unit of time, one or more sensor readings satisfying a certain condition (e.g., presence of a hazardous condition above a given threshold or within a certain range), etc., when clicked; a continuous rewind button 640b for continuously rewinding through an event when depressed; a stop button 640c for stopping the action of any one or more other buttons; a play button 640d for playing an event; a continuous fast-forward button 640b for continuously fast-forwarding through an event when depressed; and a discrete fast-forward button 640f for fast-forwarding by a discrete unit of time, one or more sensor readings satisfying a certain condition (e.g., presence of a hazardous condition above a given threshold or within a certain range), etc., when clicked. It is appreciated that the foregoing is used for an expository purpose, and the playback control 640 need not include the foregoing or be limited to the foregoing.

Adverting to FIG. 6A, an event (e.g., Event 1) is being played back with the continuous rewin_{d} button 640b of the playback control 640. The hazardous condition 515 of FIG. 6A is depicted beginning in its position near the sensor represented by sensor representation 516c, which is further described in reference to FIG. 5E.

Adverting to FIG. 6B, the event (e.g., Event 1) is still being played back with the continuous rewind button 640b of the playback control 640. The hazardous condition 515 of FIG. 6B is depicted as having moved into its earlier position between the sensors represented by sensor representations 516c and 516d, which is further described in reference to FIG. 5D.

Adverting to FIG. 6C, the event (e.g., Event 1) is stopped from further playback with the stop button 640c of the playback control 640. The hazardous condition 515 of FIG. 6C is depicted as having moved into its earlier position between the sensors represented by sensor representations 516d and 516e, which is further described in reference to FIG. 5C.

Playback of the event shown across FIGS. 6A-6C may be displayed in the GUI on a directly connected output system (e.g., a directly connected display) or another output system such as output system 130 (e.g., a networked display). It is appreciated that playback of the event may be displayed on a system not networked to the sensor-based detection system 120 if the system is operable to receive the relevant sensor readings and metadata (e.g., in an exported Java Archive or JAR file) by some other data transfer means for subsequent playback of the event.

Adverting to FIGS. 7A-7C, the sensor-based detection system 120 may determine a live or historical path associated with movement of a hazardous condition about two or more sensors for display on a directly connected output system (e.g., a directly connected display) or another output system such as output system 130 (e.g., a networked display). As described herein, the location module 270 of the sensor-based detection system 120 may be configured for spatial analysis (e.g., triangulation), and the location module 270, the data warehouse module 230, and the visualization module 250 may be configured to operate in concert to determine and display the path associated with the movement of the hazardous condition about two or more sensors.

As shown in FIG. 7A, playback of the event (e.g., Event 1) is stopped, and a path 734 associated with the movement of the hazardous condition 515 about the cluster of three sensors at Gate 11 of Terminal 1 of LAX is displayed. The path 734 depicted in FIG. 7A is a portion of the entire path for the movement of the hazard, which portion may be defined by zoom level manipulation, active user selection, or the like.

As shown in FIG. 7B, playback of the event (e.g., Event 1) remains stopped, the zoom level of the map is adjusted with the zoom control 514 from that shown in FIG. 7A (e.g., Gate 11 of Terminal 1 of LAX) to Terminal 1 of LAX, and the path 734 associated with the movement of the hazardous condition 515 represents the entire path of the hazardous condition 515 about the first cluster of three sensors at Gate 11 (e.g., represented by sensor representations 516a) and the second cluster of three sensors at Gate 12 (e.g., represented by sensor representations 516a) of Terminal 1 of LAX. As evidenced from the map 512 and the path 734 of the hazardous condition 515, the hazardous condition 515 originated at Gate 12 and ended at Gate 11 of Terminal 1 of LAX.

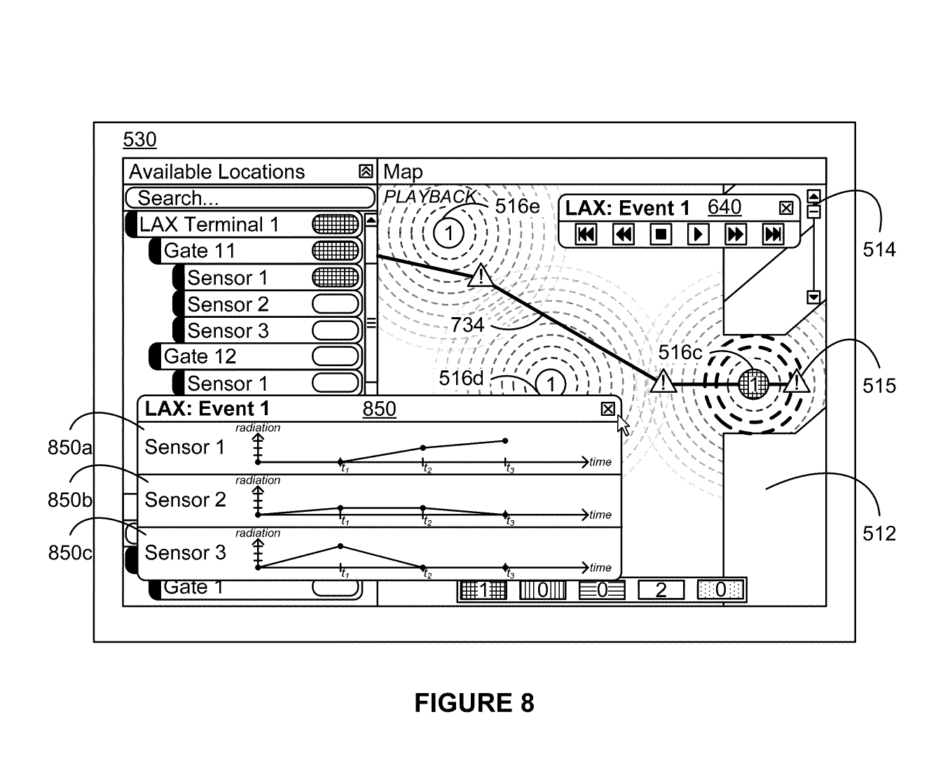

The GUI may be operable to include a graph window 850 (discussed in FIG. 8) or the like for current and/or historical sensor readings, which may be useful for reviewing events (e.g., one or more sensor readings satisfying a certain condition such as hazardous condition above a given threshold or within a certain range). The graph window 850 may display graphs corresponding to sensor readings for one or more sensors defined by zoom level manipulation, active user selection, or the like. To facilitate reviewing events, the graphs corresponding to the sensor readings for the one or more sensors may be normalized to the same scale in the graph window 850. The graphs corresponding to the sensor readings for the one or more sensors may be tied to the playback control 640, if the playback control 640 is active. If the playback control 640 is not active, the graphs corresponding to the sensor readings for the one or more sensors may be live.

Adverting to FIG. 8, playback of the event (e.g., Event 1) remains stopped, the zoom level of the map is adjusted with the zoom control 514 from that shown in FIG. 7B (e.g., Terminal 1 of LAX) back to Gate 11 of Terminal 1 of LAX, and the path 734 associated with the movement of the hazardous condition 515 again represents a portion of the path 734 defined by zoom level manipulation, active user selection, or the like. As shown, graphs 850a, 850b, and 850c correspond to the sensors represented by sensor representations 516c, 516d, and 516e, respectively. The graphs 850a, 850b, and 850c are normalized to the same time scale, as depicted by sensor readings at times t₁, t₂, and t₃, which correspond to the sensor readings for the sensors represented by sensor representations 516c, 516d, and 516e depicted in FIGS. 5C, 5D, and 5E. Because the playback control 640 is active and stopped at time t₃ in FIG. 8, the graphs 850a, 850b, and 850c are also stopped at t₃. At a glance, it should be discernable by a user from the graph window 850 that the hazardous condition 515 at Gate 11 of Terminal 1 of LAX entered the gate proximate to Sensor 3 (e.g., represented by sensor representation 516e) at time t₁, passed near Sensor 2 (e.g., represented by sensor representation 516d) at t₂, and stopped at the gate proximate to Sensor 3 (e.g., represented by sensor representation 516c) at time t₃.

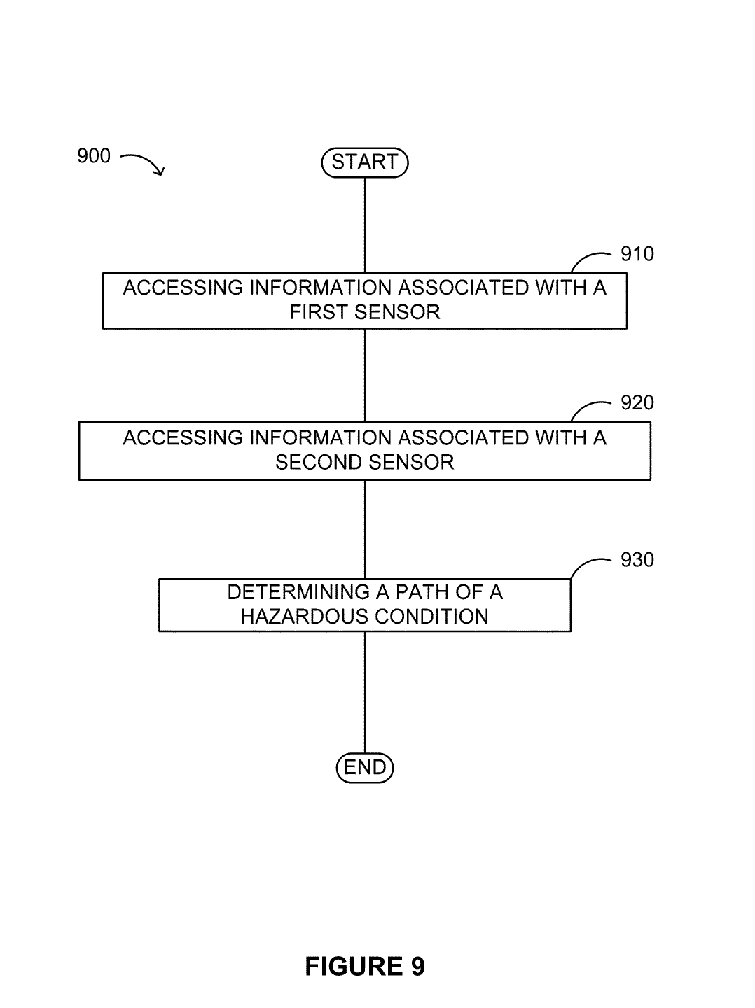

Adverting to FIG. 9, FIG. 9 shows a flow diagram for determining a path in accordance with some embodiments. As shown, flow diagram 900 includes a step 910 for accessing an information associated with a first sensor; followed by a step 920 for accessing an information associated with a second sensor; and followed by a step 930 for determining a path of a hazardous condition.

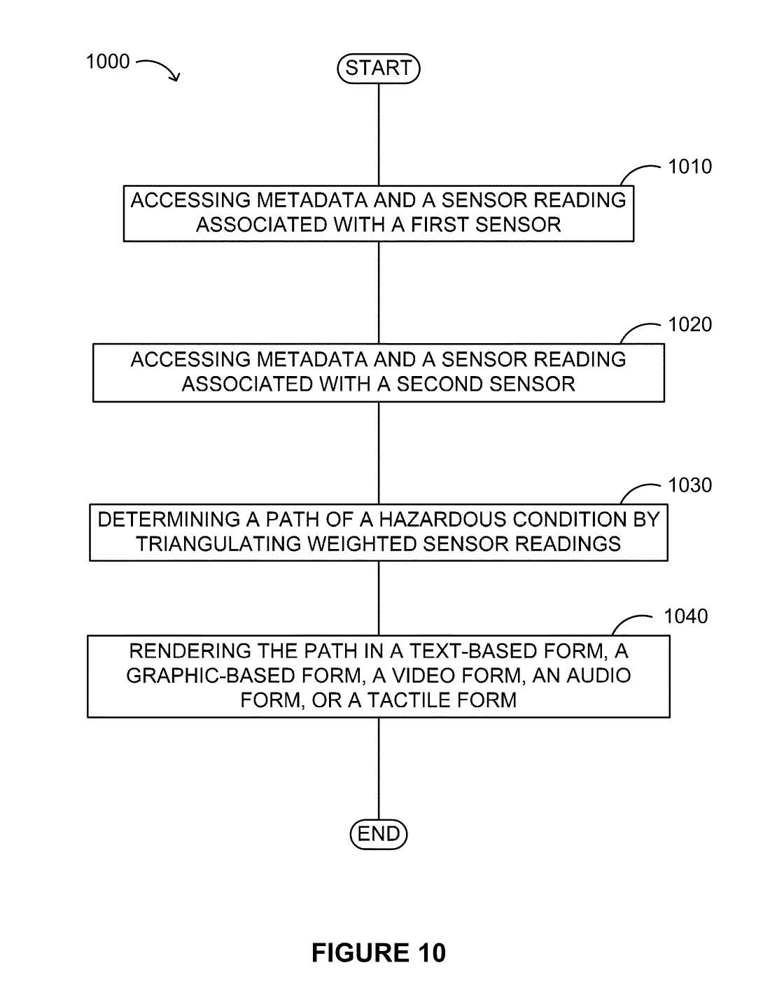

Adverting to FIG. 10, FIG. 10 shows a flow diagram for determining a path in accordance with some embodiments. As shown, flow diagram 1000 includes a step 1010 for accessing metadata and a sensor reading associated with a first sensor; followed by a step 1020 for accessing metadata and a sensor reading associated with a second sensor; followed by a step 930 for determining a path of a hazardous condition by triangulating weighted sensor readings; and followed by a step 1040 for rendering the path in a text-based form, a graphic-based form, a video form, an audio form, or tactile-based form.

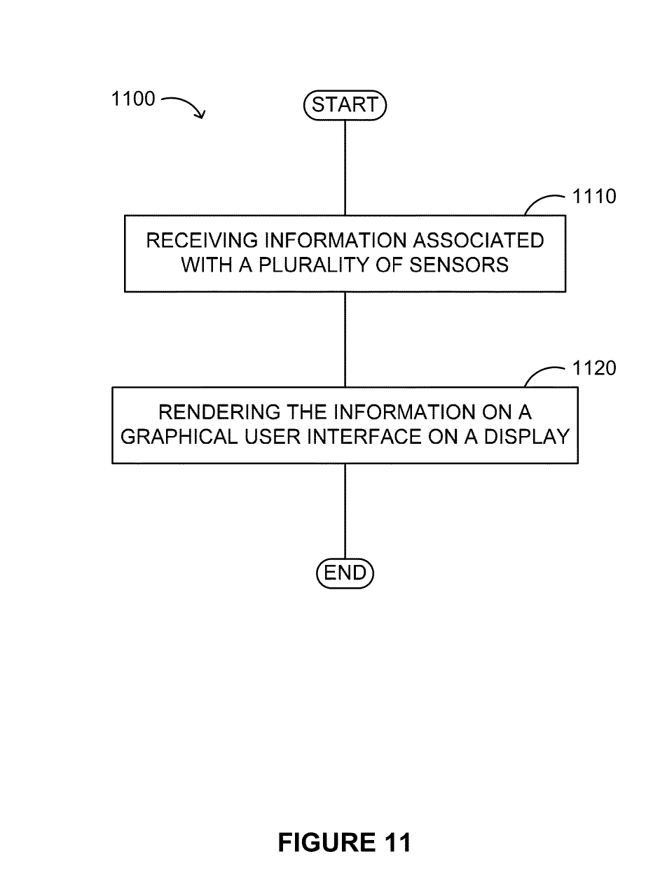

Adverting to FIG. 11, FIG. 11 shows a flow diagram for rendering sensor-related information on a GUI in accordance with some embodiments. As shown, flow diagram 1100 includes a step 1110 for receiving information associated with a plurality of sensors, followed by a step 1120 for rendering the information on a graphical user interface on a display.

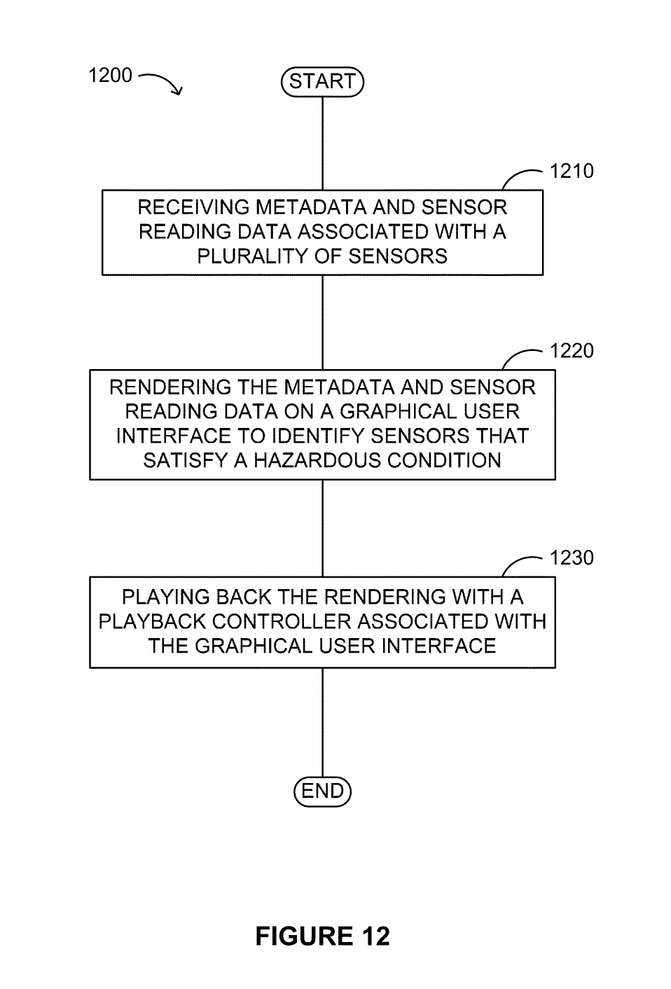

Adverting to FIG. 12, FIG. 12 shows a flow diagram for rendering sensor-related information on a GUI in accordance with some embodiments. As shown, flow diagram 1200 includes a step 1210 for receiving metadata and sensor reading data associated with a plurality of sensors; followed by a step 1220 for rendering the metadata and sensor reading data on a graphical user interface to identify sensors that satisfy a hazardous condition; and followed by a step 1230 for playing back the rendering with a playback controller associated with the graphical user interface.

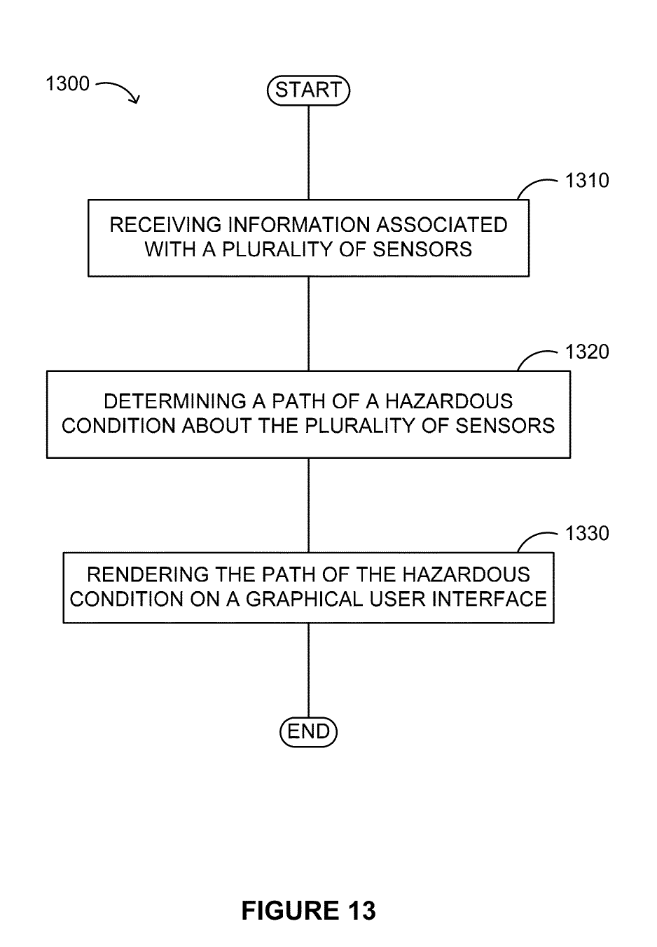

Adverting to FIG. 13, FIG. 13 shows a flow diagram for rendering a path on a GUI in accordance with some embodiments. As shown, flow diagram 1300 includes a step 1310 for receiving information associated with a plurality of sensors; followed by a step 1320 for determining a path of a hazardous condition about the plurality of sensors; and followed by a step 1330 for rendering the path of the hazardous condition on a graphical user interface.

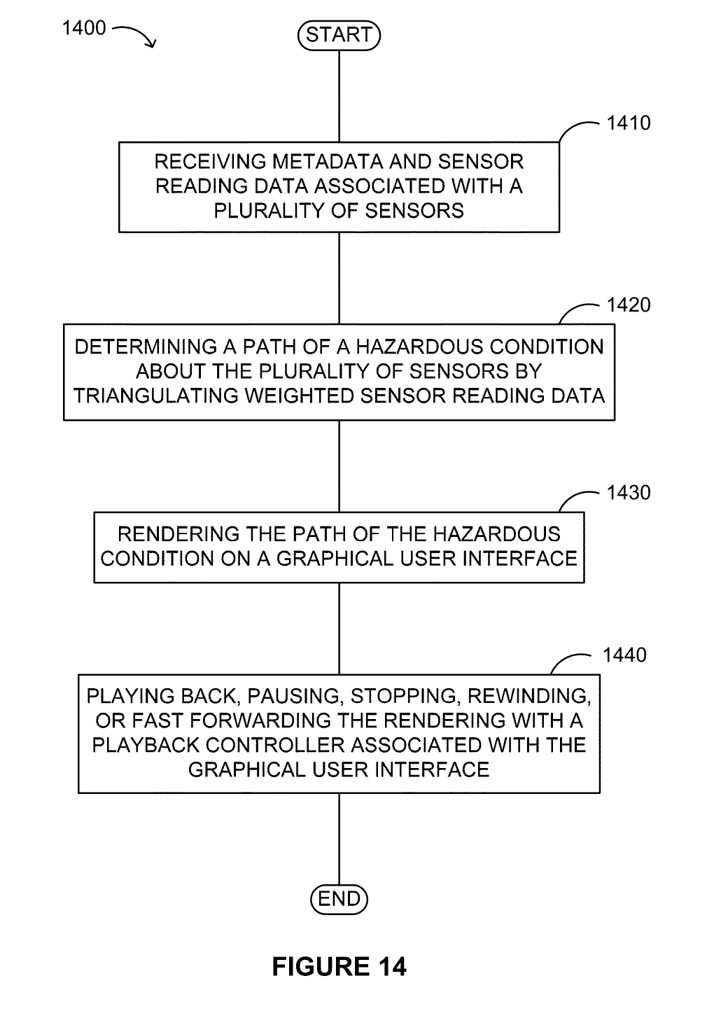

Adverting to FIG. 14, FIG. 14 shows a flow diagram for rendering a path on a GUI in accordance with some embodiments. As shown, flow diagram 1400 includes a step 1410 for receiving metadata and sensor reading data associated with a plurality of sensors; followed by a step 1420 for determining a path of a hazardous condition about the plurality of sensors by triangulating weighted sensor reading data; followed by a step 1430 for rendering the path of the hazardous condition on a graphical user interface; and followed by a step 1440 for playing back, pausing, stopping, rewinding, or fast-forwarding the rendering with a playback controller associated with the graphical user interface.

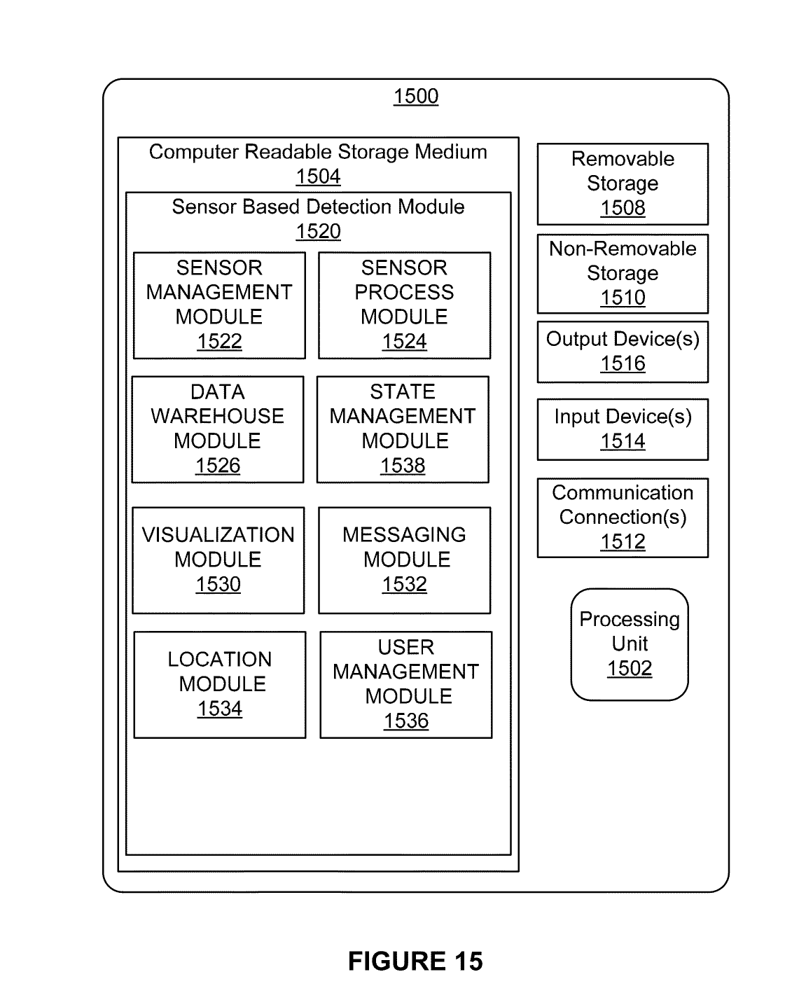

Referring now to FIG. 15, a block diagram of a computer system in accordance with some embodiments is shown. With reference to FIG. 15, a system module for implementing embodiments including, but not limited to, those of flow diagrams 900, 1000, 1100, 1200, 1300, and 1400, includes a general purpose computing system environment, such as computing system environment 1500. Computing system environment 1500 may include, but is not limited to, servers, switches, routers, desktop computers, laptops, tablets, mobile devices, and smartphones. In its most basic configuration, computing system environment 1500 typically includes at least one processing unit 1502 and computer readable storage medium 1504. Depending on the exact configuration and type of computing system environment, computer readable storage medium 1504 may be volatile (such as RAM), non-volatile (such as ROM, flash memory, etc.) or some combination of the two. Portions of computer readable storage medium 1504 when executed facilitate determining a path of a hazardous condition (e.g., flow diagrams 900, 1000, 1100, 1200, 1300, and 1400).

Additionally, in various embodiments, computing system environment 1500 may also have other features/functionality. For example, computing system environment 1500 may also include additional storage (removable and/or non-removable) including, but not limited to, magnetic or optical disks or tape. Such additional storage is graphically illustrated by removable storage 1508 and non-removable storage 1510. Computer storage media includes volatile and nonvolatile, removable and non-removable media implemented in any method or technology for storage of information such as computer readable instructions, data structures, program modules or other data. Computer readable medium 1504, removable storage 1508 and non-removable storage 1510 are all examples of computer storage media. Computer storage media includes, but is not limited to, RAM, ROM, EEPROM, flash memory or other memory technology, expandable memory (e.g., USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 1500. Any such computer storage media may be part of computing system environment 1500.

In some embodiments, computing system environment 1500 may also contain communications connection(s) 1512 that allow it to communicate with other devices. Communications connection(s) 1512 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 1512 may allow computing system environment 1500 to communicate over various networks types including, but not limited to, fiber channel, small computer system interface (SCSI), Bluetooth, Ethernet, Wi-Fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 1512 connect to may run a plurality of network protocols including, but not limited to, transmission control protocol (TCP), user datagram protocol (UDP), internet protocol (IP), real-time transport protocol (RTP), real-time transport control protocol (RTCP), file transfer protocol (FTP), and hypertext transfer protocol (HTTP).

In further embodiments, computing system environment 1500 may also have input device(s) 1514 such as keyboard, mouse, a terminal or terminal emulator (either connected or remotely accessible via telnet, SSH, http, SSL, etc.), pen, voice input device, touch input device, remote control, etc. Output device(s) 1516 such as a display, a terminal or terminal emulator (either connected or remotely accessible via telnet, SSH, http, SSL, etc.), speakers, light emitting diodes (LEDs), etc. may also be included.

In some embodiments, computer readable storage medium 1504 includes a hierarchy network assembler 1522, a traffic flow module 1526, a crosslink communication module 1528, and an uplink/downlink communication module 1530. The hierarchy network assembler module 1522 is operable to form a network of hierarchical structure. The traffic flow module 1526 may be used to direct the traffic flow (e.g., forwarding, blocking, etc.). The crosslink communication module 1528 operates to generate, send and receive crosslink messages to other devices within the same domain. The uplink/downlink communication module 1530 is operable to generate, send and receive uplink/downlink messages between devices having a parent/child domain relationship

It is appreciated that implementations according to some embodiments are described with respect to a computer system are merely examples and not intended to limit the scope of the concepts presented herein. For example, embodiments may be implemented on devices such as switches and routers, which may contain application specific integrated circuits (ASICs), field programmable gate arrays (FPGAs), etc. It is appreciated that these devices may include a computer readable medium for storing instructions for implementing methods according to flow diagrams 900, 1000, 1100, 1200, 1300, and 1400.

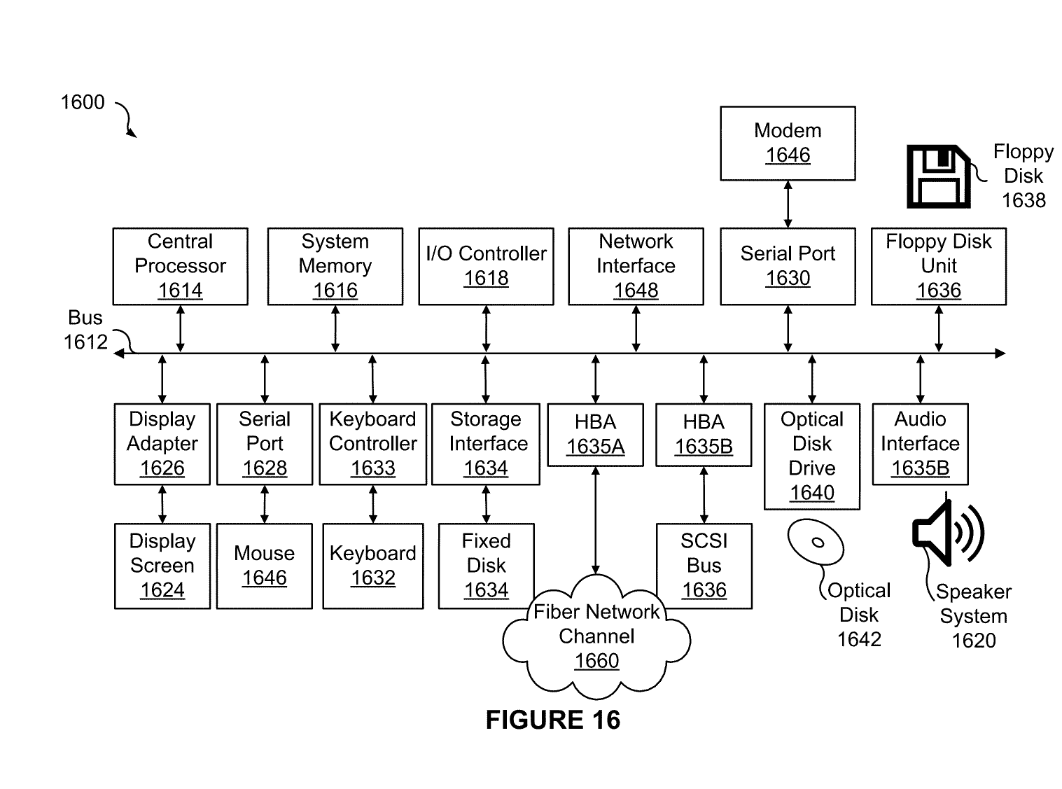

Referring now to FIG. 16, a block diagram of another computer system in accordance with some embodiments is shown. FIG. 16 depicts a block diagram of a computer system 1610 suitable for implementing of systems and methods such as those described herein. Computer system 1610 includes a bus 1612 which interconnects major subsystems of computer system 1610, such as a central processor 1614, a system memory 1617 (typically RAM, but which may also include ROM, flash RAM, or the like), an input/output controller 1618, an external audio device, such as a speaker system 1620 via an audio output interface 1622, an external device, such as a display screen 1624 via display adapter 1626, serial ports 1628 and 1630, a keyboard 1632 (interfaced with a keyboard controller 1633), a storage interface 1634, a floppy disk drive 1637 operative to receive a floppy disk 1638, a host bus adapter (HBA) interface card 1635A operative to connect with a Fiber Channel network 1690, a host bus adapter (HBA) interface card 1635B operative to connect to a SCSI bus 1639, and an optical disk drive 1640 operative to receive an optical disk 1642. Also included are a mouse 1646 (or other point-and-click device, coupled to bus 1612 via serial port 1628), a modem 1647 (coupled to bus 1612 via serial port 1630), and a network interface 1648 (coupled directly to bus 1612). It is appreciated that the network interface 1648 may include one or more Ethernet ports, wireless local area network (WLAN) interfaces, etc., but are not limited thereto. System memory 1617 includes a hierarchy generator and traffic flow module 1650 which is operable to construct a hierarchical network and to further update traffic flows in response to a topology change within the hierarchical network. According to some embodiments, the hierarchical generator and traffic flow module 1650 may include other modules for carrying out various tasks. For example, hierarchy generator and traffic flow module 1650 may include the hierarchy network assembler 1522, the traffic flow module 1526, the crosslink communication module 1528, and the uplink/downlink communication module 1530, as discussed with respect to FIG. 15 above. It is appreciated that the traffic flow module 1650 may be located anywhere in the system and is not limited to the system memory 1617. As such, residing of the traffic flow module 1650 within the system memory 1617 is merely an example and not intended to limit the scope of the concepts presented herein. For example, parts of the traffic flow module 1650 may reside within the central processor 1614 and/or the network interface 1648 but are not limited thereto.

Bus 1612 allows data communication between central processor 1614 and system memory 1617, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 1610 are generally stored on and accessed via a computer readable medium, such as a hard disk drive (e.g., fixed disk 1644), an optical drive (e.g., optical drive 1640), a floppy disk unit 1637, or other storage medium. Additionally, applications can be in the form of electronic signals modulated in accordance with the application and data communication technology when accessed via network modem 1647 or interface 1648.

Storage interface 1634, as with the other storage interfaces of computer system 1610, can connect to a standard computer readable medium for storage and/or retrieval of information, such as a fixed disk drive 1644. Fixed disk drive 1644 may be a part of computer system 1610 or may be separate and accessed through other interface systems. Network interface 1648 may provide multiple connections to other devices. Furthermore, modem 1647 may provide a direct connection to a remote server via a telephone link or to the Internet via an internet service provider (ISP). Network interface 1648 may provide one or more connection to a data network, which may include any number of networked devices. It is appreciated that the connections via the network interface 1648 may be via a direct connection to a remote server via a direct network link to the Internet via a POP (point of presence). Network interface 1648 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 16 need not be present to practice systems and methods such as those described herein. The devices and subsystems can be interconnected in different ways from that shown in FIG. 16. The operation of a computer system such as that shown in FIG. 16 is readily known in the art and is not discussed in detail in this application. Code to implement systems and methods such as those described herein can be stored in computer-readable storage media such as one or more of system memory 1617, fixed disk 1644, optical disk 1642, or floppy disk 1638. The operating system provided on computer system 1610 may be MS-DOS®, MS-WINDOWS®, OS/2®, UNIX®, Linux®, or any other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

As such, provided herein is a method comprising collecting sensor readings from two or more sensors of a plurality of sensors deployed in an environment; storing collected sensor readings in a data structure with metadata corresponding to the plurality of sensors; and determining a path of a hazardous condition about the two or more sensors from the collected sensor readings and the metadata. In some embodiments, the plurality of sensors deployed in the environment are fixed, semi-fixed, mobile, or a combination thereof. In some embodiments, the metadata comprises location-based information for the plurality of sensors. In some embodiments, determining the path of the hazardous condition comprises triangulation of the collected sensor readings. In some embodiments, the triangulation comprises weighting sensor readings by strength, proximity of the hazard, or both. In some embodiments, determining the path of the hazardous condition comprises determining the path about two or more individual sensors in a location of the environment or two or more groups of sensors in different locations of the environment. In some embodiments, the method further comprises processing the path into a human-comprehendible form. In some embodiments, the human-comprehendible is selected from a text-based form, a graphic-based form, a video form, an audio form, and a tactile form. In some embodiments, the method further comprises archiving the path of the hazardous condition for later retrieval.

Also provided herein is a method comprising collecting sensor readings from two or more sensors of a plurality of sensors deployed in an environment; storing collected sensor readings in a data structure; and determining a path of a hazardous condition about the two or more sensors from the collected sensor readings. In some embodiments, the plurality of sensors deployed in the environment are fixed, semi-fixed, mobile, or a combination thereof. In some embodiments, determining the path of the hazardous condition comprises triangulation of weighted sensor readings weighted by strength, proximity of the hazard, or both. In some embodiments, determining the path of the hazardous condition comprises determining the path about two or more individual sensors in a location of the environment or two or more groups of sensors in different locations of the environment. In some embodiments, the method further comprises processing the path into a human-comprehendible form selected from a text-based form, a graphic-based form, a video form, an audio form, and a tactile form. In some embodiments, the method further comprises archiving the path of the hazardous condition for later retrieval.

Also provided herein is a computer-readable storage medium having stored therein, computer executable instructions that, if executed by a device, cause the device to perform a method comprising collecting sensor readings from two or more sensors of a plurality of sensors deployed in an environment; storing collected sensor readings in a data structure with metadata corresponding to locations of the two or more sensors; and determining a path of a hazardous condition about the two or more sensors from the collected sensor readings and the metadata. In some embodiments, determining the path of the hazardous condition comprises triangulation of weighted sensor readings weighted by strength, proximity of the hazard, or both. In some embodiments, determining the path of the hazardous condition comprises determining the path about two or more individual sensors in a location of the environment or two or more groups of sensors in different locations of the environment. In some embodiments, the method further comprises processing the path into a human-comprehendible form selected from a text-based form, a graphic-based form, a video form, an audio form, and a tactile form. In some embodiments, the method further comprises archiving the path of the hazardous condition for later retrieval.

Also provided herein is a method comprising accessing an information associated with a first sensor of a plurality of sensors, wherein the information associated with the first sensor includes metadata and a sensor reading; accessing an information associated with a second sensor of the plurality of sensors, wherein the information associated with the second sensor includes metadata and a sensor reading; and determining a path of a hazardous condition using the information from the first sensor and the second sensor. In some embodiments, a sensor of the plurality of sensors is selected from a group consisting of fixed sensors, semi-fixed sensors, and mobile sensors. In some embodiments, the metadata comprises location-based information of a sensor. In some embodiments, the determining comprises triangulating to locate the hazardous condition using sensor readings of the plurality of sensors. In some embodiments, the triangulation further comprises weighting sensor readings respective to strength and sensitivity. In some embodiments, determining the path of the hazardous condition is associated with a path between a group of sensors of the plurality of sensors. In some embodiments, further comprising rendering information associated with the path of the hazardous condition. In some embodiments, the rendition is selected from a group consisting of a text-based form, a graphic-based form, a video form, an audio form, and a tactile form. In some embodiments, the method further comprises storing the path of the hazardous condition.

Also provided herein is a method comprising receiving information associated with a plurality of sensors, wherein the information comprises metadata and sensor readings; determining whether a hazardous condition is present within a vicinity of the plurality of sensors, wherein the determining of whether the hazardous condition is present is based on the received information; and in response to determining that the hazardous condition is present, determining a path of the hazardous condition based on the received information. In some embodiments, the plurality of sensors deployed in the environment is selected from a group consisting of fixed sensors, semi-fixed sensors, mobile sensors, and combinations thereof. In some embodiments, determining the path of the hazardous condition comprises triangulation of weighted sensor readings weighted by strength and sensitivity. In some embodiments, determining the path of the hazardous condition comprises determining the path about two or more individual sensors in a location of the environment or two or more groups of sensors in different locations of the environment. In some embodiments, the method further comprises processing the path into a human-comprehendible form selected from a group consisting of a text-based form, a graphic-based form, a video form, an audio form, and a tactile form. In some embodiments, the method further comprises archiving the path of the hazardous condition for later retrieval.

Also provided herein is a computer-readable storage medium having stored therein, computer executable instructions that, if executed by a device, cause the device to perform a method comprising accessing an information associated with a first sensor of a plurality of sensors, wherein the information associated with the first sensor includes metadata and a sensor reading; accessing an information associated with a second sensor of the plurality of sensors, wherein the information associated with the second sensor includes metadata and a sensor reading; and determining a path of a hazardous condition using the information from the first sensor and the second sensor. In some embodiments, the determining comprises triangulating to locate the hazardous condition using weighted sensor readings of the plurality of sensors respective to strength and sensitivity. In some embodiments, determining the path of the hazardous condition is associated with a path between a group of sensors of the plurality of sensors. In some embodiments, the method further comprises rendering information associated with the path of the hazardous condition into a rendition selected from a group consisting of a text-based form, a graphic-based form, a video form, an audio form, and a tactile form. In some embodiments, the method further comprises storing the path of the hazardous condition.

Also provided herein is a method comprising collecting sensor readings from one or more sensors of a plurality of sensors deployed in an environment; storing collected sensor readings in a data structure with metadata corresponding to the plurality of sensors; and providing the collected sensor readings and the metadata in a format suitable for display in a graphical user interface. In some embodiments, the plurality of sensors deployed in the environment are fixed, semi-fixed, mobile, or a combination thereof. In some embodiments, the metadata comprises location-based information for the plurality of sensors. In some embodiments, the graphical user interface comprises a map pane for a map of the environment; and sensor representations on the map corresponding to individual sensors or groups of two or more sensors of the plurality of sensors. In some embodiments, a zoom level of the map defines the sensor representations corresponding to individual sensors or groups of two or more sensors. In some embodiments, selecting one or more sensor representations on the map displays the collected sensor readings, the metadata, or both for the one or more sensor representations selected. In some embodiments, the sensor representations visually indicate the collected sensor readings bucketed according to pre-defined hazard levels. In some embodiments, the graphical user interface further comprises a playback control for reviewing the sensor representations and the collected sensor readings historically. In some embodiments, the playback control comprises one or more controls selected from play, pause, stop, continuous rewind, discrete rewind, continuous fast-forward, and discrete fast-forward. In some embodiments, the graphical user interface further comprises a location pane for selecting one or more sensors by location.

Also provided herein is a method comprising collecting sensor readings from one or more sensors of a plurality of sensors deployed in an environment; and providing collected sensor readings and metadata corresponding to the plurality of sensors in a format suitable for display in a graphical user interface. In some embodiments, the graphical user interface comprises a map pane for a map of the environment; a location pane; and sensor representations on the map and in the location pane corresponding to individual sensors or groups of two or more sensors of the plurality of sensors. In some embodiments, a zoom level of the map and a hierarchical relationship of the plurality of sensors defines the sensor representations corresponding to individual sensors or groups of two or more sensors in the map and the location pane, respectively. In some embodiments, selecting one or more sensor representations on the map displays the collected sensor readings, the metadata, or both for the one or more sensor representations selected. In some embodiments, the method further comprises archiving the collected sensor readings and the metadata for reviewing corresponding sensor representations in the graphical user interface historically with a playback control.

Also provided herein is a computer-readable storage medium having stored therein, computer executable instructions that, if executed by a device, cause the device to perform a method comprising collecting sensor readings from one or more sensors of a plurality of sensors deployed in an environment; and providing collected sensor readings and metadata corresponding to the plurality of sensors in a format suitable for display in a graphical user interface. In some embodiments, the graphical user interface comprises a map pane for a map of the environment; a location pane; and sensor representations on the map and in the location pane corresponding to individual sensors or groups of two or more sensors of the plurality of sensors. In some embodiments, a zoom level of the map and a hierarchical relationship of the plurality of sensors defines the sensor representations corresponding to individual sensors or groups of two or more sensors in the map and the location pane, respectively. In some embodiments, selecting one or more sensor representations on the map displays the collected sensor readings, the metadata, or both for the one or more sensor representations selected. In some embodiments, the method further comprises archiving the collected sensor readings and the metadata for reviewing corresponding sensor representations in the graphical user interface historically with a playback control.

Also provided herein is a method comprising receiving information associated with a plurality of sensors configured to detect a hazardous condition, wherein the information includes metadata and sensor reading data; and rendering the information on a graphical user interface on a display device, wherein the rendering is configured to identify sensors of the plurality of sensors that satisfy the hazardous condition. In some embodiments, a sensor of the plurality of sensors is selected from a group consisting of fixed sensors, semi-fixed sensors, and mobile sensors. In some embodiments, the metadata comprises location-based information of a sensor. In some embodiments, the graphical user interface comprises a map pane for displaying sensor representations on a map for a subset of sensors of the plurality of sensors. In some embodiments, the method further comprises zooming in and out of the map in response to manipulation of a zoom level controller displayed on the graphical user interface, wherein the zoom level is configured to adjust grouping of the sensor representations and their respective locations on the map. In some embodiments, the method further comprises displaying the metadata and sensor reading data associated with a selected sensor representation for a sensor of the plurality of sensors. In some embodiments, the method further comprises rendering a sensor representation for a sensor of the plurality of sensors on the graphical user interface, wherein the sensor representation visually indicates a status associated with the rendered sensor, and wherein the status is associated with a hazard level. In some embodiments, the graphical user interface further comprises a playback controller configured to display sensor representations and associated historical sensor readings for the sensor representations. In some embodiments, the playback controller comprises one or more controllers selected from a group consisting of play, pause, stop, continuous rewind, discrete rewind, continuous fast-forward, and discrete fast-forward controllers. In some embodiments, the graphical user interface further comprises a location pane configured to render locations associated with sensors in response to a user selection of the location.

Also provided herein is a graphical user interface comprising a first element configured to display indicators associated with a plurality of sensors arranged in a hierarchical relationship by location; and a second element configured to display sensor representations associated with the plurality of sensors on a map corresponding to the locations, wherein the plurality of sensors is configured to detect a hazardous condition. In some embodiments, the first element comprises a location pane, the second element comprises a map pane, and the location pane and the map pane are configured to display in one or more windows of the graphical user interface. In some embodiments, a level of the hierarchical relationship in the location pane and a zoom level of the map in the map pane define individual sensors or groups of sensors in the location pane and the map pane, respectively. In some embodiments, selecting a sensor representation on the map for a sensor of the plurality of sensors displays the sensor readings, the metadata, or both for the sensor representation selected. In some embodiments, the graphical user interface further comprises a playback controller configured to display historical sensor readings, wherein the playback controller comprises one or more controllers selected from a group consisting of play, pause, stop, continuous rewind, discrete rewind, continuous fast-forward, and discrete fast-forward controllers.

Also provided herein is a computer-readable storage medium having stored therein, computer executable instructions that, if executed by a device, cause the device to perform a method comprising receiving information associated with a plurality of sensors configured to detect a hazardous condition, wherein the information includes metadata and sensor reading data; and rendering the information on a graphical user interface on a display device, wherein the rendering is configured to identify sensors of the plurality of sensors that satisfy the hazardous condition. In some embodiments, the graphical user interface comprises a map pane for displaying sensor representations on a map for a subset of sensors of the plurality of sensors. In some embodiments, zooming in and out of the map in response to manipulation of a zoom level controller displayed on the graphical user interface adjusts grouping of the sensor representations and their respective locations on the map. In some embodiments, the graphical user interface further comprises a location pane configured to render locations associated with sensors in response to a user selection of the location. In some embodiments, the graphical user interface further comprises a playback controller configured to display historical sensor readings, wherein the playback controller comprises one or more controllers selected from a group consisting of play, pause, stop, continuous rewind, discrete rewind, continuous fast-forward, and discrete fast-forward controllers.

Also provided herein is a method comprising collecting sensor readings from two or more sensors of a plurality of sensors deployed in an environment; determining a path of a hazard about the two or more sensors from collected sensor readings and metadata for the plurality of sensors; and providing the collected sensor readings and the path in a format suitable for display in a graphical user interface. In some embodiments, the plurality of sensors deployed in the environment are fixed, semi-fixed, mobile, or a combination thereof. In some embodiments, determining the path of the hazard comprises triangulation of weighted sensor readings by strength, proximity of the hazard, or both. In some embodiments, determining the path of the hazard comprises determining the path about two or more individual sensors in a location of the environment or two or more groups of sensors in different locations of the environment. In some embodiments, the graphical user interface comprises a map pane for a map of the environment; a location pane; and sensor representations on the map and in the location pane corresponding to individual sensors or groups of two or more sensors of the plurality of sensors. In some embodiments, a zoom level of the map and a hierarchical relationship of the plurality of sensors defines the sensor representations corresponding to individual sensors or groups of two or more sensors in the map and the location pane, respectively. In some embodiments, selecting one or more sensor representations on the map displays the collected sensor readings, the metadata, or both for the one or more sensor representations selected. In some embodiments, the sensor representations visually indicate the collected sensor readings bucketed according to pre-defined hazard levels. In some embodiments, the graphical user interface further comprises a playback control for reviewing the sensor representations, the collected sensor readings, the path, or a combination thereof historically. In some embodiments, the playback control comprises one or more controls selected from play, pause, stop, continuous rewind, discrete rewind, continuous fast-forward, and discrete fast-forward.

Also provided herein is a method comprising collecting sensor readings from two or more sensors of a plurality of sensors deployed in an environment; determining a path of a hazard about the two or more sensors; and providing the collected sensor readings and the path in a format suitable for display in a graphical user interface. In some embodiments, determining the path of the hazard comprises triangulation of weighted sensor readings by strength, proximity of the hazard, or both. In some embodiments, determining the path of the hazard comprises determining the path about two or more individual sensors in a location of the environment or two or more groups of sensors in different locations of the environment. In some embodiments, the graphical user interface comprises a map pane for a map of the environment; a location pane; and sensor representations on the map and in the location pane corresponding to individual sensors or groups of two or more sensors of the plurality of sensors. In some embodiments, the graphical user interface further comprises a playback control for reviewing the sensor representations, the collected sensor readings, the path, or a combination thereof historically.

Also provided herein is a computer-readable storage medium having stored therein, computer executable instructions that, if executed by a device, cause the device to perform a method comprising collecting sensor readings from two or more sensors of a plurality of sensors deployed in an environment; determining a path of a hazard about the two or more sensors; and providing the collected sensor readings and the path in a format suitable for display in a graphical user interface. In some embodiments, determining the path of the hazard comprises triangulation of weighted sensor readings by strength, proximity of the hazard, or both. In some embodiments, determining the path of the hazard comprises determining the path about two or more individual sensors in a location of the environment or two or more groups of sensors in different locations of the environment. In some embodiments, the graphical user interface comprises a map pane for a map of the environment; a location pane; and sensor representations on the map and in the location pane corresponding to individual sensors or groups of two or more sensors of the plurality of sensors. In some embodiments, the graphical user interface further comprises a playback control for reviewing the sensor representations, the collected sensor readings, the path, or a combination thereof historically.

Also provided herein is a method comprising receiving information associated with a plurality of sensors configured to detect a hazardous condition, wherein the information includes metadata and sensor reading data; determining a path of the hazardous condition about the plurality of sensors from the information; and rendering the path of the hazardous condition on a graphical user interface on a display device. In some embodiments, a sensor of the plurality of sensors is selected from a group consisting of fixed sensors, semi-fixed sensors, and mobile sensors. In some embodiments, the metadata comprises location-based information of a sensor. In some embodiments, determining the path of the hazardous condition comprises triangulating to locate the hazardous condition using weighted sensor readings of the plurality of sensors. In some embodiments, determining the path of the hazardous condition is associated with a path between a group of sensors of the plurality of sensors. In some embodiments, the graphical user interface comprises a map pane for rendering sensor representations on a map for a subset of sensors of the plurality of sensors. In some embodiments, the graphical user interface further comprises a location pane for rendering indicators associated with locations for the subset of sensors. In some embodiments, a hierarchical level of a location in the location pane and a zoom level of the map in the map pane correspond to the subset of sensors in the location pane and the map pane, respectively. In some embodiments, selecting a sensor representation on the map displays the sensor readings, the metadata, or both for the sensor representation selected. In some embodiments, the graphical user interface further comprises a playback controller configured to display historical sensor reading data and the path. In some embodiments, the playback controller comprises one or more controllers selected from a group consisting of play, pause, stop, continuous rewind, discrete rewind, continuous fast-forward, and discrete fast-forward controllers.

Also provided herein is a graphical user interface comprising a first element configured to display indicators associated with a plurality of sensors arranged in a hierarchical relationship by location; and a second element configured to display sensor representations associated with the plurality of sensors on a map corresponding to the locations and a rendered path of a hazardous condition as detected by the plurality of sensors. In some embodiments, the first element comprises a location pane, the second element comprises a map pane, and the location pane and the map pane are configured to display in one or more windows of the graphical user interface. In some embodiments, a level in the hierarchical relationship in the location pane and a zoom level of the map in the map pane define individual sensors or groups of sensors in the location pane and the map pane, respectively. In some embodiments, selecting a sensor representation on the map for a sensor of the plurality of sensors displays the sensor readings, the metadata, the rendered path, or a combination thereof corresponding to the sensor representation selected. In some embodiments, the graphical user interface further comprises a playback controller configured to display historical sensor readings and paths, wherein the playback controller comprises one or more controllers selected from a group consisting of play, pause, stop, continuous rewind, discrete rewind, continuous fast-forward, and discrete fast-forward controllers.

Also provided herein is a computer-readable storage medium having stored therein, computer executable instructions that, if executed by a device, cause the device to perform a method comprising receiving information associated with a plurality of sensors configured to detect a hazardous condition, wherein the information includes metadata and sensor reading data; determining a path of the hazardous condition about the plurality of sensors from the information; and rendering the path of the hazardous condition on a graphical user interface on a display device. In some embodiments, determining the path of the hazardous condition comprises triangulating to locate the hazardous condition using weighted sensor readings of the plurality of sensors. In some embodiments, the graphical user interface comprises a map pane for displaying sensor representations on a map for a subset of sensors of the plurality of sensors, optionally with the path of the hazardous condition. In some embodiments, the graphical user interface further comprises a location pane configured to render locations associated with sensors in response to a user selection of the location. In some embodiments, the graphical user interface further comprises a playback controller configured to display historical sensor readings and paths, wherein the playback controller comprises one or more controllers selected from a group consisting of play, pause, stop, continuous rewind, discrete rewind, continuous fast-forward, and discrete fast-forward controllers.

The foregoing description, for purpose of explanation, has been described with reference to specific embodiments. However, the illustrative discussions above are not intended to be exhaustive or to limit the concepts presented herein. Many modifications and variations are possible in view of the above teachings.

What is claimed is:

1. A method comprising:
receiving information associated with a plurality of sensors configured to detect a hazardous condition,
wherein the information includes metadata and sensor reading data; and
rendering the information on a graphical user interface on a display device,
wherein the rendering is configured to identify sensors of the plurality of sensors that satisfy the hazardous condition.

2. The method of claim 1, wherein a sensor of the plurality of sensors is selected from a group consisting of fixed sensors, semi-fixed sensors, and mobile sensors.

3. The method of claim 1, wherein the metadata comprises location-based information of a sensor.

4. The method of claim 1, wherein the graphical user interface comprises a map pane for displaying sensor representations on a map for a subset of sensors of the plurality of sensors.

5. The method of claim 4 further comprising:
zooming in and out of the map in response to manipulation of a zoom level controller displayed on the graphical user interface, wherein the zoom level is configured to adjust grouping of the sensor representations and their respective locations on the map.

6. The method of claim 1 further comprising:
displaying the metadata and sensor reading data associated with a selected sensor representation for a sensor of the plurality of sensors.

7. The method of claim 1 further comprising:
rendering a sensor representation for a sensor of the plurality of sensors on the graphical user interface,
wherein the sensor representation visually indicates a status associated with the rendered sensor, and
wherein the status is associated with a hazard level.

8. The method of claim 7, wherein the graphical user interface further comprises:
a playback controller configured to display sensor representations and associated historical sensor readings for the sensor representations.

9. The method of claim 8, wherein the playback controller comprises one or more controllers selected from a group consisting of play, pause, stop, continuous rewind, discrete rewind, continuous fast-forward, and discrete fast-forward controllers.

10. The method of claim 1, wherein the graphical user interface further comprises:
a location pane configured to render locations associated with sensors in response to a user selection of the location.

11. A graphical user interface comprising:
a first element configured to display indicators associated with a plurality of sensors arranged in a hierarchical relationship by location; and
a second element configured to display sensor representations associated with the plurality of sensors on a map corresponding to the locations,
wherein the plurality of sensors is configured to detect a hazardous condition.

12. The graphical user interface of claim 11, wherein the first element comprises a location pane, wherein the second element comprises a map pane, and wherein the location pane and the map pane are configured to display in one or more windows of the graphical user interface.

13. The graphical user interface of claim 12, wherein a level of the hierarchical relationship in the location pane and a zoom level of the map in the map pane define individual sensors or groups of sensors in the location pane and the map pane, respectively.

14. The graphical user interface of claim 12, wherein selecting a sensor representation on the map for a sensor of the plurality of sensors displays the sensor readings, the metadata, or both corresponding to the sensor representation selected.

15. The graphical user interface of claim 11, further comprising:
a playback controller configured to display historical sensor readings, wherein the playback controller comprises one or more controllers selected from a group consisting of play, pause, stop, continuous rewind, discrete rewind, continuous fast-forward, and discrete fast-forward controllers.

16. A computer-readable storage medium having stored therein, computer executable instructions that, if executed by a device, cause the device to perform a method comprising:
receiving information associated with a plurality of sensors configured to detect a hazardous condition,
wherein the information includes metadata and sensor reading data; and
rendering the information on a graphical user interface on a display device,
wherein the rendering is configured to identify sensors of the plurality of sensors that satisfy the hazardous condition.

17. The computer-readable storage medium of claim 16, wherein the graphical user interface comprises a map pane for displaying sensor representations on a map for a subset of sensors of the plurality of sensors.

18. The computer-readable storage medium of claim 17, wherein zooming in and out of the map in response to manipulation of a zoom level controller displayed on the graphical user interface adjusts grouping of the sensor representations and their respective locations on the map.

19. The computer-readable storage medium of claim 17, wherein the graphical user interface further comprises a location pane configured to render locations associated with sensors in response to a user selection of the location.

20. The computer-readable storage medium of claim 17, wherein the graphical user interface further comprises a playback controller configured to display historical sensor readings, and wherein the playback controller comprises one or more controllers selected from a group consisting of play, pause, stop, continuous rewind, discrete rewind, continuous fast-forward, and discrete fast-forward controllers.
